(19) United States
(12) Patent Application Publication
(10) Pub. No.: US 2004/0228508 A1
(43) Pub. Date: Nov. 18, 2004

(54) Signal processing apparatus and controlling method

(75) Inventor: Kazuyuki Shigeta, Kanagawa (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/835,905

(22) Filed: Apr. 29, 2004

(30) Foreign Application Priority Data
May 16, 2003 (JP) 2003/139030
Nov. 26, 2003 (JP) 2003/395397

(51) Int. Cl. G06K 9/00; G06K 9/36

(52) U.S. Cl. 382/124; 382/284

(57) ABSTRACT

A signal processing apparatus includes an image capture device for image capture of a subject and a control member for controlling a first mode and a second mode. In the first mode, the image capture device captures a first partial image of the subject with a plurality of exposure conditions during relative movement of the subject and the image capture device. The control member sets an exposure condition in accordance with the first partial image. In the second mode, the image capture member sequentially captures a plurality of second partial images of the subject in accordance with the exposure condition set by the control member. Thus, the signal processing apparatus can capture images of the subject with an optimum exposure condition.

### BACKGROUND OF THE INVENTION

1. Field of the Invention

The present invention relates to a signal processing apparatus and a controlling method for processing signals that are obtained by sequentially capturing partial images of a subject during relative movement of the subject and an image capture device for capturing the images.

2. Description of the Related Art

A biometric verification system using fingerprints, faces, irises, palmprints, and the like obtains biometric images sent from an image obtaining device, extracts features from the obtained images, and compares the extracted information with registered data, thereby authenticating an individual.

Examples of a detection system for an image obtaining device for use in a biometric verification system include an optical system using a charge coupled device (CCD) sensor or a complementary metal-oxide semiconductor (CMOS) sensor, an electrostatic capacity system, a pressure sensing system, a heat sensitive system, and an electric-field detecting system. Alternatively, the detection system can be classified into two image-capturing systems. One is an area type system in which a two-dimensional sensor is used to simultaneously obtain images of a subject. The other is a sweep type system in which a one-dimensional sensor or a strip two-dimensional sensor having about five to twenty pixels in the sub-scanning direction is used to sequentially capture a plurality of partial images of a subject.

Conventionally, such a biometric verification system performs various types of processing, such as contrast improvement and edge enhancement, on images obtained by the image obtaining device and then performs feature-extraction processing to perform comparison.

If, however, the original captured image does not have a certain level of sufficient image quality, the accuracy of the feature extraction declines, so that the comparison accuracy in the biometric verification system also decreases. For example, for an optical fingerprint sensor, the brightness level may greatly vary depending on a difference in light transmittance, a difference in size of an individual finger, and a change in external-light due to environmental factors, including an outdoor or indoor, daytime or nighttime, or the like. In particular, when the biometric verification system is installed on a portable telephone, a PDA (personal data assistant), or the like, such a change in external light becomes more significant. In such cases, when an image that is somewhat saturated or that has somewhat under-saturated black is obtained, sufficient features often cannot be extracted from the obtained image because of insufficient density/gradation data.

An automatic exposure (AE) correction function may be used to control the exposure condition by capturing an image multiple times. This arrangement, however, requires repeating data acquisition multiple times until an adequate exposure is obtained, thus taking time until an adequate exposure is reached. One example of such an arrangement is a sweep-type fingerprint sensor, which uses the above-mentioned one-dimensional sensor or the strip two-dimensional sensor having about five to twenty pixels in the sub-scanning direction, for obtaining an entire image by combining images of a subject which are sequentially captured in the sub-scanning direction. Particularly, with the sweep-type fingerprint sensor, in order to achieve adequate exposure, it is necessary to instruct the user to sweep (move for scanning) his/her finger multiple times. Thus, there is a problem in that products employing such an arrangement substantially impair the usability.

Moreover, with such a sweep-type fingerprint sensor, a finger is placed above the sensor and is moved relative to the image-capturing surface. Thus, during the relative movement, the speed, the position, the pressing pressure, the manner of placing the finger, a region of the finger (e.g., the top joint or the tip of the finger), the environment, the surface condition of the finger, and the like vary, which may greatly change brightness resulting from the exposure. One sweep-type fingerprint sensor performs image-combining processing (which is also referred to as “image reconstruction processing”), which involves determining a correlation coefficient between sequentially-captured partial images by computation, detecting the same fingerprint region among lines of the partial images, and connecting the partial images. When the brightness changes during the relative movement, the state of exposure varies between the partial images. Thus, the correlation value decreases due to a brightness difference even though the partial images belong to the same fingerprint region. This results in a failure in the image-combining procedure, making it impossible to connect the partial images. In such a case, a segment of an entire fingerprint image is lost or a stretched or shrunken image is provided. As a result, there are problems in that the matching rate of extracted features to registered fingerprint features declines and the matching accuracy decreases. Another sweep-type fingerprint sensor performs verification by comparing the partial image with a pre-registered image without detecting the same fingerprint region among lines of the partial images, and connecting the partial images. When the brightness changes during the relative movement, the state of exposure varies between the partial images. Thus, the correlation value decreases due to a brightness difference among the partial images. As a result, there are problems in that the matching rate of extracted features to registered fingerprint features declines and the matching accuracy also decreases.

### SUMMARY OF THE INVENTION

In view of the above-described problems, the present invention provides a signal processing apparatus and a controlling method which sequentially capture a plurality of partial images of a subject with an adequate exposure condition. The present invention also provides a signal processing apparatus and a controlling method which can enhance the image quality of captured partial images, can effectively extract feature points, and can equalize resolution of the partial images. The present invention also provides a signal processing apparatus and a controlling method which can improve biometric-information verification accuracy.

According to an aspect of the present invention, a signal processing apparatus includes an image capture device for image capture of a subject and a control member for controlling a first mode and a second mode. In the first mode, the image capture device captures a first partial image of the subject with a plurality of exposure conditions during relative movement of the subject and the image capture device. The control member sets an exposure condition in accordance with the first partial image. In the second mode, the image capture device sequentially captures a plurality of second partial images of the subject in accordance with the exposure condition set by the control member.

According to another aspect of the present invention, a signal processing apparatus includes an image capture device for capturing at least one partial image of a subject during relative movement of the subject and the image capture device, and an amount-of-exposure control member for controlling an amount of exposure for the image capture device. The signal processing apparatus further includes a detection member for detecting a brightness level for each of the at least one partial image obtained by the image capture device; and an amount-of-exposure control member for performing control to set an amount of exposure for partial images to be subsequently captured, in accordance with the detected brightness level.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram schematically showing the configuration of a fingerprint verification apparatus according to a first embodiment of the present invention.

FIGS. 2A, 2B, and 2C are schematic views for illustrating an optical fingerprint sensor using a sweep-type system in the first embodiment.

FIG. 3 is a schematic view showing fingerprint images obtained by the optical fingerprint sensor using a sweep-type system in the first embodiment.

FIG. 4 is a circuit diagram showing the configuration of the image capture device in the first embodiment.

FIG. 5 is a circuit diagram showing the configuration of the image capture device in the first embodiment.

FIG. 6 is a flow chart illustrating an image-obtaining condition setting routine in the first embodiment.

FIGS. 7A, 7B, and 7C are timing charts illustrating the operation of the first embodiment.

FIGS. 8A and 8B are graphs for illustrating the operation of the first embodiment.

FIG. 9 is a schematic view for illustrating the operation of the first embodiment.

FIG. 10 is a block diagram schematically showing the configuration of a fingerprint verification apparatus according to a second embodiment of the present invention.

FIG. 11 is a flow chart illustrating an image-obtaining condition setting routine in the second embodiment.

FIGS. 12A, 12B, and 12C are timing charts illustrating the operation of the second embodiment.

FIG. 13 is a schematic view for illustrating the operation of the second embodiment.

FIG. 14 is a flow chart depicting the operation of a successive-image obtaining routine for the fingerprint verification apparatus of the present embodiment shown in FIG. 1.

FIG. 15 is a flow chart depicting the details of the amount-of-exposure-correction setting routine 1406 shown in FIG. 14.

FIG. 16 is a flow chart depicting the details of the image combining routine 1408 shown in FIG. 14.

FIG. 17 is a schematic view showing exemplary partial images obtained by a conventional method in which no exposure control is performed in response to a change in a finger's pressing pressure and an exemplary fingerprint image obtained by combination of the partial images.

FIG. 18A is a schematic view showing exemplary partial images that are obtained when the fingerprint verification apparatus of the present embodiment performs exposure control in response to a brightness change due to a change in the finger's pressing pressure.

FIG. 18B is a schematic view showing exemplary partial images obtained after the correction of the partial images (a1) to (a9) shown in FIG. 18A and an exemplary fingerprint image obtained by combining the partial images after the correction.

FIG. 19 is a schematic view showing exemplary partial images obtained by a known method in which the amount of exposure is not controlled in response to a change in an external light environment at the time of obtaining partial images and also showing an exemplary fingerprint image obtained by combining the partial images.

FIG. 20A is a schematic view showing exemplary partial images that are obtained through the control of the amount of exposure in response to a change in an external-light environment at the time of obtaining partial images.

FIG. 20B is a schematic view showing exemplary partial images obtained after the correcting the partial images (a1) to (a9) shown in FIG. 20A and an exemplary fingerprint image obtained by combining the partial images after the correction.

### DESCRIPTION OF THE PREFERRED EMBODIMENTS

Preferred embodiments of the present invention will now be described in detail with reference to the accompanying drawings.

### First Embodiment

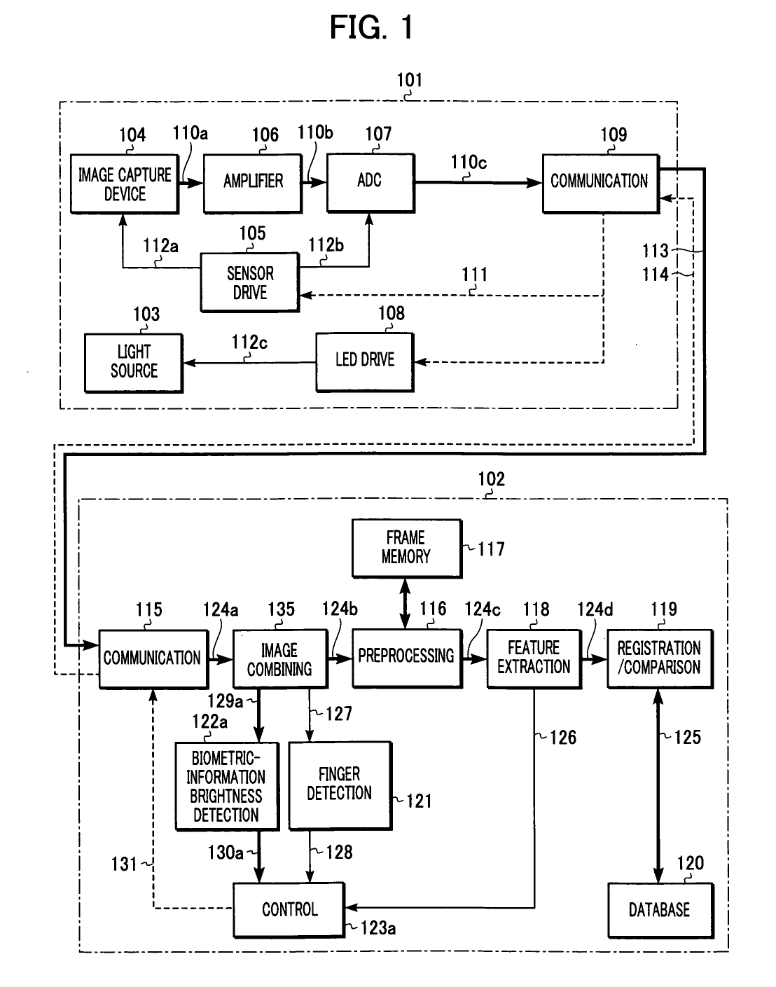

FIG. 1 is a block diagram schematically showing the configuration of a sweep-type (scan-type) fingerprint verification apparatus, which serves as a signal processing apparatus, according to a first embodiment of the present invention.

The fingerprint verification apparatus according to the present embodiment includes an image obtaining unit 101 and a verification unit 102. For example, the image obtaining unit 101 and the verification unit 102 may be a combination of an image capture unit having an image sensor and a computer implementing the functions of the verification unit 102. Alternatively, the image obtaining unit 101 and the verification unit 102 may be integrated into a single fingerprint verification unit, which is connected to an independent personal computer (not shown).

The image obtaining unit 101 shown in FIG. 1, includes an LED (light-emitting diode) 103 that serves as a light source (light illuminating member) for illumination and an LED drive 108 for controlling the brightness and the illumination timing of the LED 103.

The image obtaining unit 101 also includes a CMOS or CCD image capture device 104, which may be a one-dimensional sensor or a strip two-dimensional sensor having about five to twenty pixels in the sub-scanning direction. In the present embodiment, the image capture device 104 is a CMOS sensor having 512 pixels in the main-scanning direction and twelve pixels in the sub-scanning direction.

A sensor drive 105 controls the sampling timing of the image capture device 104 and an analog-to-digital converter (ADC) 107. An amplifier 106 clamps an analog output supplied from the image capture device 104, to a DC (direct current) level suitable for processing by the ADC 107 at the subsequent stage and appropriately amplifies the analog output. The analog output is transmitted from the image capture device 104 to the amplifier 106 via an analog image-data signal line 110a. The amplified analog output is transmitted from the amplifier 106 to the ADC 107 via an analog image-data signal line 110b. The converted (digital) signal is transmitted from the ADC 107 to a communication member 109 via a digital image-data signal line 10c.

A drive pulse is sent from the sensor drive 105 to the image capture device 104 via a signal line 112a. A drive pulse is sent from the sensor drive 105 to the ADC 107 via a signal line 112b. A drive pulse is sent from the LED drive 108 to the light source 103 via a signal line 112c. Control lines 111 are used to control the sensor drive 105 and the LED drive 108 in response to a detection signal from a biometric-information brightness detection member 122a and a detection signal from a finger detection member 121 in the verification unit 102.

Data signals are transmitted from the communication member 109 of the image obtaining unit 101 to a communication member 115 of the verification unit 102 via a data signal line 113 and control signals are transmitted from the communication member 115 of the verification unit 102 to the communication member 109 of the image obtaining unit 101 via a control signal line 114.

The verification unit 102 includes an image combining member 135 that combines images of a subject which are sequentially captured in the sub-scanning direction by the strip two-dimensional sensor.

The finger detection member 121 serves as a biometric sensor for detecting the placement of a finger and for determining whether the placed finger is a finger of a living body or a fake finger, by using image information supplied from a preprocessing member 116, which is described below. The finger detection member 121 uses fluctuations in color and/or brightness of an image to determine whether or not a subject is of a living body. The biometric-information brightness detection member 122a in the present embodiment identifies a region included in biometric information out of obtained image information and detects the brightness of the identified biometric-information region. In response to information sent from the biometric-information brightness detection member 122a and other functions (e.g., finger detection member 121 and feature extraction member 118), a control member 123a controls the image obtaining unit 101.

The preprocessing member 116 performs image processing, such as edge enhancement, in order to extract features at a subsequent stage. A frame memory 117 is used to perform image processing. A feature extraction member 118 extracts personal features. A registration/comparison member 119 registers the personal features, that are extracted by the feature extraction member 118, in a database 120 or compares the personal features with registered data for verification. The communications between the registration/comparison member 119 and the database 120 are accomplished via a data and control line 125.

Image data is transmitted from the communication member 115 to the image combining member 135 via data line 124a, from the image combining member 135 to the preprocessing member 116 via data line 124b, from the preprocessing member 116 to the feature extraction member 118 via data line 124c and from the feature extraction member 118 to the registration/comparison member 119 via data line 124d. An extraction state of the feature extraction member 118 is transmitted via signal line 126. Necessary image information is transmitted from the image combining member 135 to the finger detection member 121 via signal line 127 and to the biometric-information brightness detection member 122a via signal line 129a. The result of body detection is transmitted from the finger detection member 121 to the control member 123a via signal line 128. The result of biometric-information brightness detection is transmitted from the biometric-information brightness detection member 122a to the control member 123a via signal line 130a. A signal for controlling the image obtaining unit 101 in response to states of functions of verification unit 102 (e.g., states of biometric-information brightness detection member 122a, finger detection member 121 and feature extraction member 118) is transmitted from the control member 123a of the verification unit 102 to the image obtaining unit 101 via communication member 115.

In the present embodiment, the fingerprint verification apparatus of the present embodiment obtains a fingerprint image while setting an optimum condition for capturing images, by switching the driving of the sensor and the LED, during an image-capturing operation for scanning a finger or subject. Specifically, to achieve the switching, the sensor drive 105 and the LED drive 108 in the image obtaining unit 101 are controlled in response to finger-detection information sent from the verification unit 102 and brightness detection result obtained from a biometric-information region.

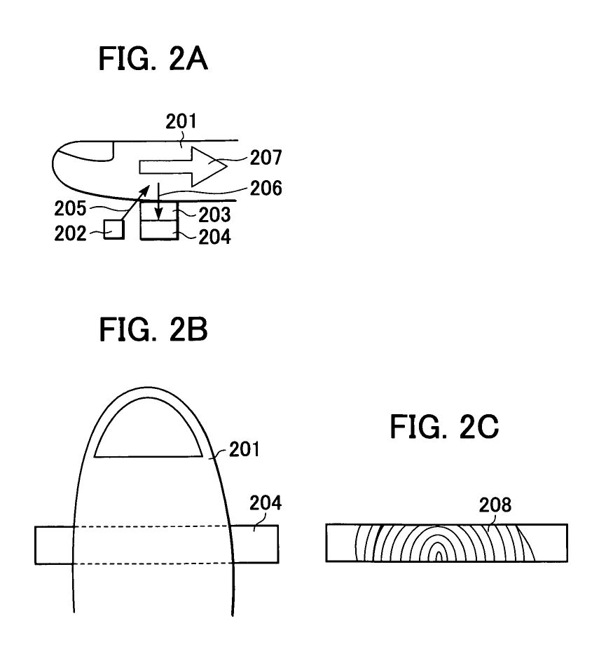

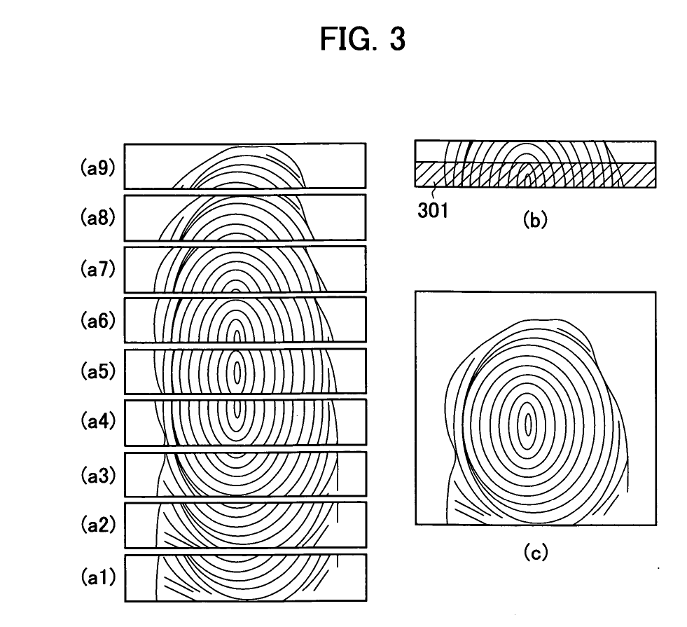

FIGS. 2A, 2B, 2C and 3 are schematic views for illustrating an optical fingerprint sensor using a system called a sweep-type system in the present embodiment.

FIG. 2A is a side view of a finger and FIG. 2B is a top view of the finger. FIG. 2C illustrates one fingerprint image obtained by the strip two-dimensional sensor. FIG. 2A shows a finger 201 and an LED 202 serving as the light source. An optical member 203 serves to guide an optical difference in the ridge/valley pattern of a fingerprint to the sensor. A sensor 204 is a one-dimensional sensor or a strip two-dimensional sensor having about five to twenty pixels in the sub-scanning direction. In this case, the sensor 204 is a CMOS or CCD image capture device. Light is emitted from the light source 202 (in a direction indicated by an arrow 205) and travels to the finger 201 and is reflected from the finger 201 in a direction (indicated by an arrow 206) that is incident on the sensor 204. The finger 201 moves (sweeps or scans) in a direction indicated by an arrow 207. FIG. 2C illustrates an example fingerprint pattern of one fingerprint image 208 obtained by the strip two-dimensional sensor 204.

Referring to FIG. 3, images (a1) to (a9) are fingerprint partial images that are sequentially obtained by the strip two-dimensional sensor 204 when the finger 201 is moved in the direction 207 shown in FIG. 2A. An image (b) is one of the images and corresponds to the partial image (a6). A region 301 of the partial image (a6) is also included in the partial image (a5) of the same finger 201. An image (c) is one fingerprint image obtained by combination of the partial images (a1) to (a9), which are obtained by the strip two-dimensional sensor 204.

Thus, those partial images are obtained by sequential image-capturing in the sub-scanning direction when the finger 201 is moved, as shown in FIG. 2A, above the sensor 204. Then, the partial images can be reconstructed into an entire fingerprint image by determining that highly correlated regions (301 in FIG. 3) of successive images have been obtained from the same region of the finger 201 and by connecting the highly correlated regions.

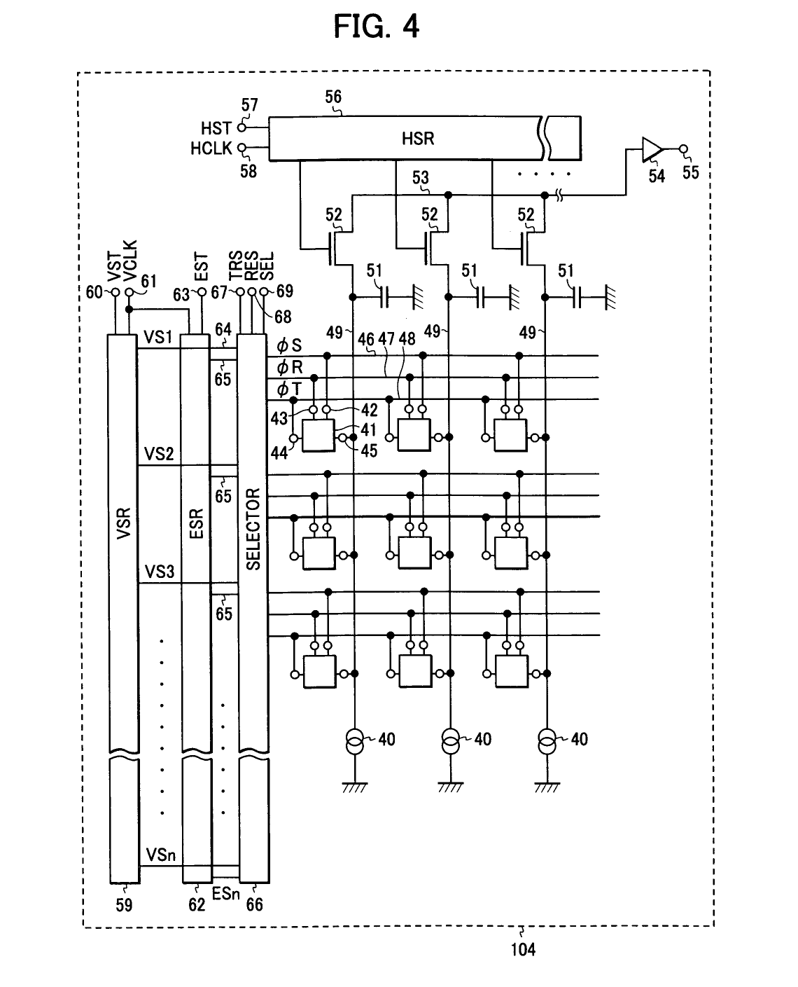

FIG. 4 is a circuit diagram of the image capture device 104 shown in FIG. 1. The image capture device 104 in the present embodiment is a strip two-dimensional sensor having about five to twenty pixels in the sub-scanning direction. More specifically, the image capture device 104 is a sensor called a sweep-type sensor for obtaining an entire image by sequentially capturing images of a finger or subject in the sub-scanning direction and by combining the captured images. Herein, the horizontal scanning direction in a typical area-sensor is referred to as a “main-scanning direction” and the vertical scanning direction is referred to as a “sub-scanning direction”. Therefore, in the description below for the image capture device 104, the main-scanning direction refers to a horizontal direction and the sub-scanning direction refers to a vertical direction.

Referring to FIG. 4, the sensor includes a plurality of pixels 41. There is an input terminal 42 for a read pulse (φS) for each pixel 41, an input terminal for a reset pulse (φR) 43 for each pixel 41, and an input terminal for a transfer pulse (φT) 44 for each pixel 41. There is also a signal read terminal (P0) 45 for each pixel 41. Signal lines 46 are used for sending the read pulse (φS) from a selector member 66, described below, to the corresponding pixels 41 in the horizontal direction. Signal lines 47 are used for sending the reset pulse (φR) from the selector member 66 to the corresponding pixels 41 in the horizontal direction, and signal lines 48 are used for sending the transfer pulse (φT) from the selector member 66 to the corresponding pixels 41 in the horizontal direction. The sensor includes constant current sources 40 and capacitances 51 that are connected to corresponding vertical signal lines 49. The sensor includes transfer switches 52. The gates of the transfer switches 52 are connected to a horizontal shift register 56 (HSR), and the sources and the drains are connected to the corresponding vertical signal lines 49 and an output signal line 53. An output amplifier 54 is connected to the output signal line 53. An output terminal 55 is connected to the output amplifier 54.

The image capture device 104 includes an input terminal for a start pulse HST 57 for the horizontal shift register (HSR) 56 and an input terminal for a transfer clock pulse HCLK 58 for the horizontal shift register 56. The image capture device 104 also includes a vertical shift register (VSR) 59, an input terminal for a start pulse VST 60 for the vertical shift register 59, and an input terminal for a transfer clock pulse VCLK 61 for the vertical shift register 59. The image capture device 104 further includes a shift register (ESR) 62 for an electronic shutter that employs a system called a rolling shutter system, which is described below. The image capture device 104 also includes an input terminal for a start pulse EST 63 for the vertical shift register 62, output lines 64 for the vertical shift register 59 (VSR), and output lines 65 for the shift register (ESR) 62 for the electronic shutter. Also included in the image capture device 104 are an input terminal for a source signal TRS 67 for the transfer pulse (φT), an input terminal for a source signal RES 68 for the reset-pulse (φR), and an input terminal for a source signal SEL 69 for the read pulse (φS).

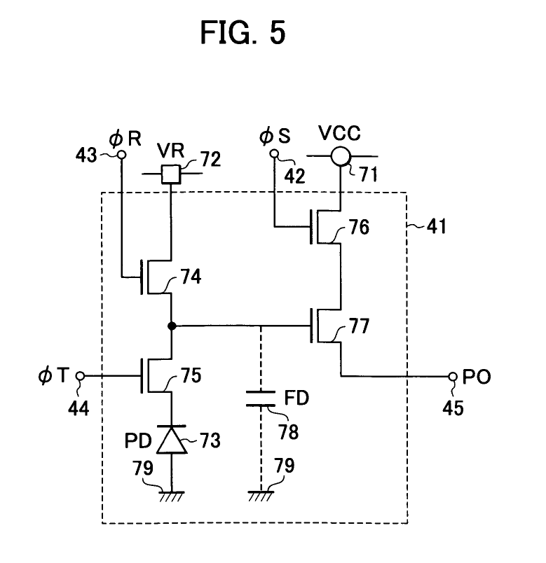

FIG. 5 is a circuit diagram illustrating further detail of one of the pixels 41 shown in FIG. 4. In FIG. 5, the pixel 41 includes a power-supply voltage VCC 71, a reset voltage VR 72, a photodiode 73, switches constituted by MOS transistors 74, 75, 76 and 77, a parasitic capacitance FD 78, and ground 79.

The operation of the image capture device 104 will now be described with reference to FIGS. 4 and 5. First, the switch 74 for reset and the switch 75, which is connected to the photodiode 73, are put into OFF states, and electrical charge is stored in the photodiode 73 in response to incident light.

Thereafter, when the switch 76 is in an OFF state, the switch 74 is turned ON, thereby resetting the parasitic capacitance 78. Next, the switch 74 is turned OFF and the switch 76 is turned ON, so that charge in the reset state is read out to the signal read terminal 45.

Next, the switch 76 is put into the OFF state, and the switch 75 is turned ON, so that the charge stored in the photodiode 73 is transferred to the parasitic capacitance 78. Next, the switch 75 is put into the OFF state and the switch 76 is turned ON, so that a charge signal is read out to the signal read terminal 45.

The drive pulses φS, φR, and φT for the MOS transistors are created by the vertical shift registers 59 and 62 and the selector member 66, as described below, and are supplied to the input terminals 42, 43 and 44 of the pixels through the corresponding signal lines 46, 47 and 48, respectively. With respect to one pulse of a clock signal input from the input terminal 60, one pulse of the signal TRS, one pulse of the signal RES, and one pulse of the signal SEL are input to the corresponding input terminals 67, 68 and 69, respectively. Thus, the drive pulses φS, φR, and φT are output in synchronization with the respective signals SEL, RES, and TRS. As a result, the drive pulses φS, φR, and φT are supplied to the corresponding input terminals 42, 43 and 44, respectively.

The signal read terminals 45 are connected to the constant current sources 40 through the vertical signal lines 49 and are also connected to the vertical-signal-line capacitances 51 and the transfer switches 52. The charge signals are transferred to the vertical-signal-line capacitances 51 through the vertical signal lines 49. Then, in accordance with outputs from the horizontal shift register 56, the transfer switches 52 are sequentially driven, so that the signals in the vertical-signal-line capacitances 51 are sequentially read out to the output signal line 53 and are output from the output terminal 55 via the output amplifier 54. In this case, the vertical shift register (VSR) 59 starts scanning in response to the start pulse VST input via the input terminal 60, and the transfer clock pulse VCLK input via the input terminal 61 is sequentially transferred through the output lines 64 in the order of VS1, VS2, . . . , and VSn. The vertical shift register (ESR) 62 for the electronic shutter starts scanning in response to the start pulse EST input via the input terminal 63, and the transfer clock pulse VCLK input via the input terminal 61 is sequentially transferred to the output lines 65.

First, the first line (first pixel row) from above is selected, and, in accordance with scanning of the horizontal shift register 56, the pixels 41 connected to the first line are selected from left to right, thereby outputting signals. When the first line is finished, the second line is selected, and, similarly, in accordance with scanning of the horizontal shift register 56, the pixels 41 connected to the second line are selected from left to right, thereby outputting signals.

In the same manner, in response to sequential scanning of the vertical shift register 59, scanning is performed from the top to the bottom, i.e., from the first line to the n-th line, thereby outputting images for one screen.

The exposure period of a sensor depends on a storage period in which an image-capture pixel 41 stores light-induced charge and a period in which light from a subject enters the image-capture pixel 41.

Unlike an interline transfer (IT) or frame interline transfer (FIT) CCD device, the CMOS sensor used herein does not have a light-shielded buffer memory. Thus, even in a period when signals obtained by some of the pixels 41 are sequentially read, the other pixels 41 whose signals are not yet read are continually exposed. Thus, when screen outputs are sequentially read, the exposure time becomes substantially equal to the screen reading time.

However, when an LED is used as the light source, for example, blocking the entrance of external light with a light-shielding member or the like, makes it possible to regard only the period when the LED is lit as the exposure period.

Further, as another method for controlling the exposure time, a driving system called a rolling shutter system for the electronic shutter (a focal plane shutter) is employed for CMOS sensor. In the rolling shutter system, the vertical scanning for the start of charge storage and the vertical scanning for the end thereof are performed in parallel. This allows the setting of the exposure time for vertical scan lines for the start and end of the storage. In FIG. 4, the shift register (ESR) 62 serves as a vertical-scanning shift register for resetting the pixels and starting charge-storage, and the vertical shift register (VSR) 59 serves as a vertical-scanning shift register for transferring electrical charges and ending charge-storage. When an electronic shutter function is used, the shift register 62 is driven prior to the vertical shift register 59, and a period of time corresponding to the interval becomes the exposure time.

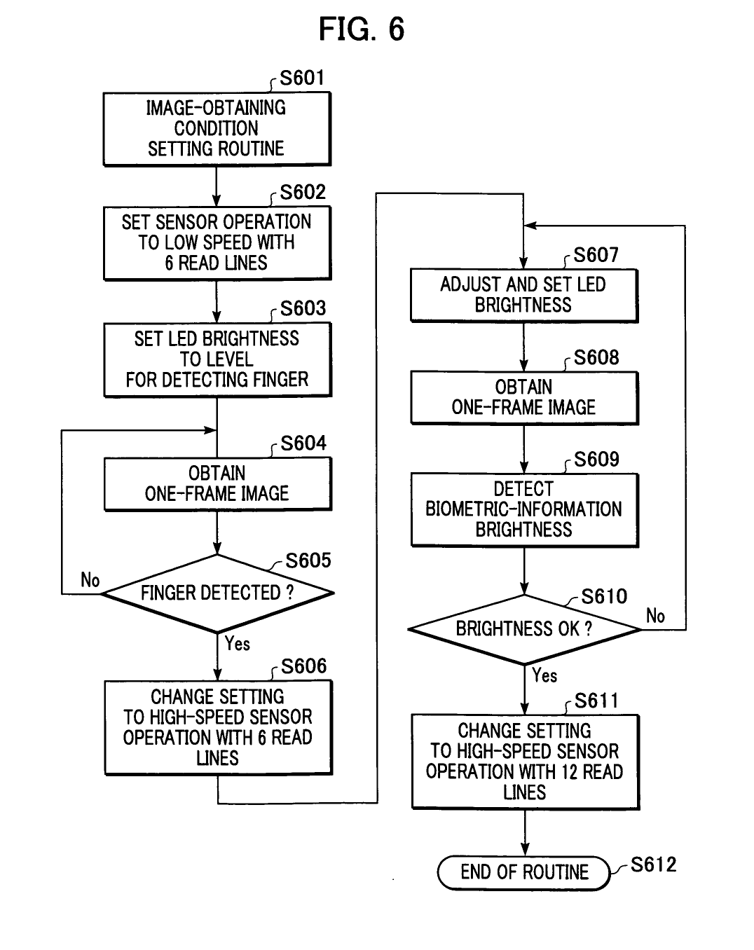

The operation of the present embodiment will now be described with reference to FIGS. 6 to 9.

FIG. 6 is a flow chart depicting an image-obtaining condition setting routine for the fingerprint verification system of the present embodiment. In the routine described below, the verification unit 102 sets an image-obtaining condition for the image obtaining unit 101 by controlling the sensor drive 105 and the LED drive 108 in accordance with finger detection information and biometric brightness-information.

First, in step S601, the process enters an image-obtaining condition setting routine. In step S602, the control member 123a of the verification unit 102 controls the sensor drive 105 to change the number of lines to be read in the sensor sub-scanning direction from twelve, which is the normal value, to six. In this case, the number of lines to be read in the sub-scanning direction is reduced by alternatively “skipping” the operations. Further, in order to reduce power consumption, the operation for obtaining partial images is performed at a low speed, by applying an enable signal such that the operation is performed at a rate of one clock per two clock pulses.

In step S603, the control member 123a of the verification unit 102 controls the LED drive 108 to set the LED brightness to a low level that is sufficient to detect the presence/absence of a finger. Thus, the sensor is put into an image-obtaining mode for detecting a finger.

In step S604, a one-frame partial image is obtained. In step S605, a determination is made as to whether or not a finger is present. When a finger is not detected (no in step S605), the process returns to step S604. When the finger is detected (yes in step S605), the process proceeds to step S606.

In step S606, the control member 123a of the verification unit 102 controls the sensor drive 105 to convert the enable signal, which has caused the operation at a rate of one clock per two clock pulses, into a signal for a normal operation in which the clock signal is input every time, while maintaining the number of lines to be read in the sensor sub-scanning direction at sixth. As a result, the operation for obtaining partial images is performed at a high speed.

In step S607, the control member 123a of the verification unit 102 controls the LED drive 108 to set the LED brightness to an arbitrary value. Consequently, the sensor is put into an image-obtaining mode for setting an exposure condition.

In step S608, a one-frame partial image is obtained. In step S609, the brightness of a portion including biometric information, i.e., the brightness of a fingerprint portion, is detected. In step S610, a determination is made as to whether the detected brightness falls within a predetermined range. When it is determined that the brightness is out of the range (no in step S610), processing returns to step S607 where the LED brightness is set again in such a manner that a brightness lower than the range is increased and a brightness higher than the range is reduced.

On the other hand, when it is determined in step S610 that the brightness is in the predetermined range, in step S611, the control member 123a of the verification unit 102 controls the sensor drive 105 to change the number of lines to be read in the sensor sub-scanning direction from six to twelve, which is the normal value. At this point, the enable signal acts as a signal for a normal operation in which the clock signal is input every time. As a result, with the exposure condition being set to an optimum value, the sensor operation is put into the default image-obtaining mode for capturing fingerprint images. In step S612, the image-obtaining condition setting routine ends.

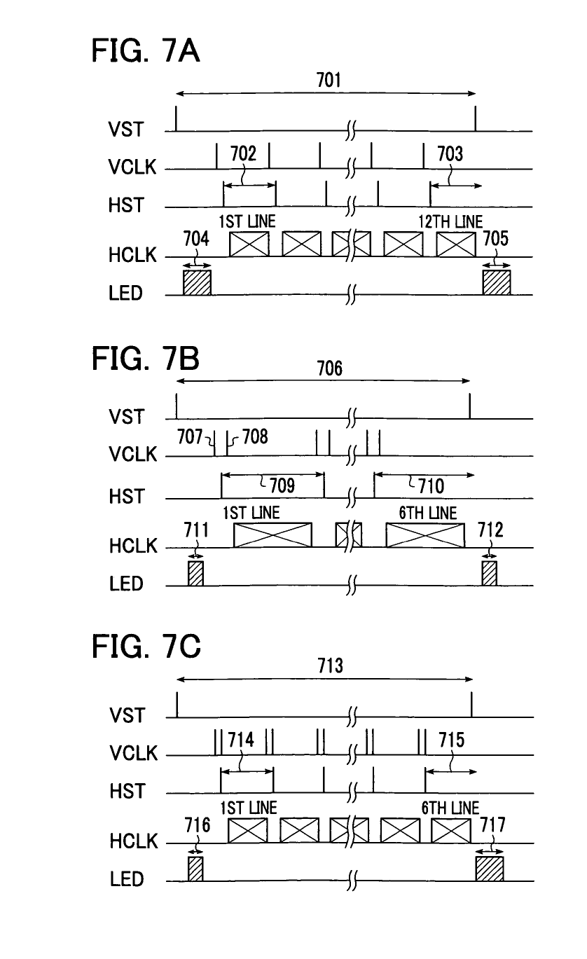

FIG. 7A shows the operation timings of the sensor and the LED in the default image-obtaining mode for capturing fingerprint images, FIG. 7B shows the operation timings of the sensor and the LED in the image-obtaining mode for detecting a finger, and FIG. 7C shows the operation timings of the sensor and the LED in the image-obtaining mode for setting an exposure condition.

In FIGS. 7A, 7B and 7C, VST and VCLK indicate a start pulse and a transfer clock pulse, respectively, for the vertical shift register (VSR) 59 in the sensor sub-scanning direction (the vertical scanning direction, i.e., the same direction as the finger movement direction in the present embodiment). HST and HCLK indicate a start pulse and a transfer clock pulse, respectively, for the horizontal shift register (HSR) 56 in the sensor main-scanning direction (the horizontal scanning direction, i.e., a direction substantially perpendicular to the finger movement direction in the present embodiment). LED indicates an LED illumination pulse. The horizontal axis indicates an illumination period. As denoted by “x”, small clock pulses HCLK are present at a certain cycle.

FIG. 7A illustrates a one-frame period 701 in which one partial image is obtained for capturing a fingerprint image in the default image-obtaining mode. In period 702, an image for the first line is transferred, and, in the period 703, an image for the 12th line is transferred. An LED illumination period 704 defines the amount of exposure for a one-frame image obtained and output in the period 701. An LED illumination period 705 defines the amount of exposure for a one-frame image obtained and output in a period subsequent to the period 701. In the image-obtaining mode for capturing fingerprint images after the optimization of the amount of exposure, images are captured with a fixed amount of LED illumination, as indicated by the period 704 and 705. Also, the shift register in the sub-scanning direction does not perform the “skipping” operation, so that an image for 12 lines is obtained. Further, since the clock pulse is input every time, the shift register in the main-scanning direction is also operated at a high speed.

In the image-obtaining mode (FIG. 7B) for detecting a finger, a one-frame period 706 is used for obtaining one partial image. The transfer pulse VCLK 707, 708 in the shift register 59 in the sub-scanning direction is transferred every other pulse in a short period of time. As a result, the operations for the lines in the sub-scanning direction are alternately skipped. An image for one line in the main-scanning direction is obtained in a period 709, 710. In the period 709, an image for the first line is transferred, and in the period 710, an image output to the sixth line is transferred. An LED illumination period 711 defines the amount of exposure for a one-frame image obtained and output in the period 706. An LED illumination period 712 defines the amount of exposure for a one-frame image obtained and output in a period subsequent to the period 706. In the image-obtaining mode for detecting a finger, as indicated by the periods 711 and 712, it is sufficient for the LED to allow detection of the presence/absence of a finger, so that the illumination period is set to a minimum length. Further, since this mode is not intended to capture a fingerprint image, the shift register in the sub-scanning direction does not perform the “skipping” operation, so that an image for six lines is obtained. Additionally, since the time when a finger is placed is monitored, the operation may be performed at a low speed. Thus, the operation of the shift register in the main-scanning direction is also performed at a low speed at a rate of one operation per two clock pulses.

In the image-obtaining mode (FIG. 7C) for setting an exposure condition, a one-frame period 713 is used for obtaining one partial image. As in the case shown in FIG. 7B, the transfer pulse VCLK in the shift register in the sub-scanning direction is transferred every other pulse in a short period of time, thereby alternately skipping the operations for the lines in the sub-scanning direction. An image for one line in the main-scanning direction is obtained for each period 714, 715. In the period 714, an image for the first line is transferred, and, in the period 715, an image output to the sixth line is transferred. An LED illumination period 716 defines the amount of exposure for a one-frame image obtained and output in the period 713. An LED illumination period 717 defines the amount of exposure for a one-frame image obtained and output in a period subsequent to the period 713. In the image-obtaining mode for setting an exposure condition, the amount of exposure is adjusted to a necessary level by varying the LED illumination period, as indicated by the periods 716 and 717. At this point, while a fingerprint image has been obtained, the amount of exposure is still being adjusted. Thus, in order to optimize the amount of exposure as quickly as possible to enter the default image-capturing mode, the shift register in the sub-scanning direction performs the skipping operation, so that an image for six lines is obtained. Since a high-speed operation is desired, the operation of the shift register in the main-scanning direction is performed in a normal manner.

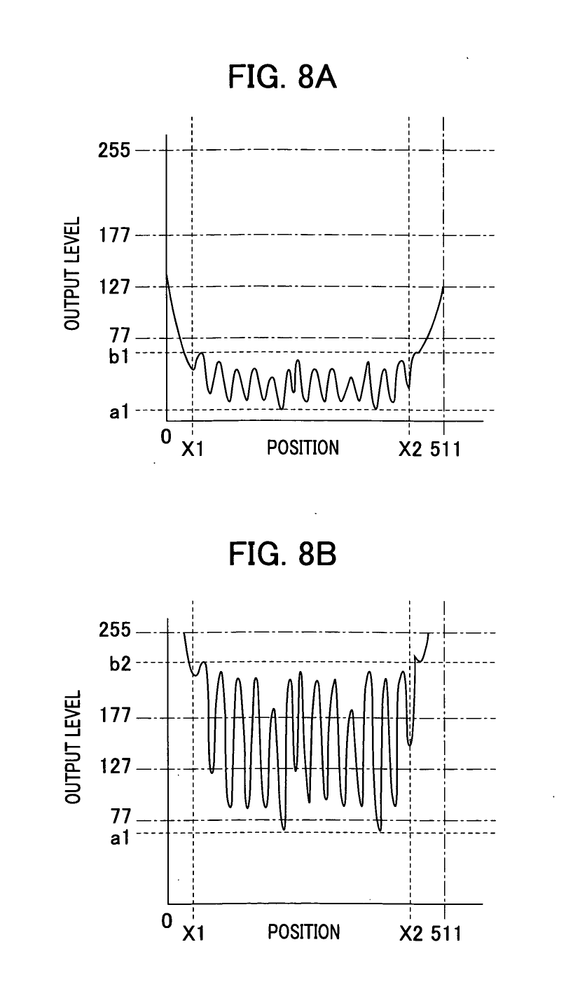

FIGS. 8A and 8B are graphs each showing the data of an image for one line in the main-scanning direction, the image being obtained in the image-obtaining mode for setting an exposure condition. FIG. 8A shows data before the amount of exposure is optimized and FIG. 8B shows data after the amount of exposure is optimized. The horizontal axis indicates a position in the main-scanning direction and the vertical axis indicates an output level of the sensor. A fingerprint pattern region obtained varies depending upon the size or the shape of a finger or a contact condition of a finger relative to the sensor. In this case, a region X1 to X2 in the main-scanning direction corresponds to a region where a fingerprint pattern that serves as biometric information is present. The biometric-information brightness detection member 122a identifies a region where a fingerprint pattern that serves as biometric information is present, and determines whether or not the brightness of the fingerprint pattern is within a predetermined range. For example, when the optimum range of the brightness is set at 127±50, in FIG. 8A, the brightness obtained by the biometric-information brightness detection member 122a is in the range of output levels a1 to b1 and the average is 72 or less. Thus, it is determined that the brightness is low. As a result, the LED illumination period is extended and the amount of exposure is optimized as shown in FIG. 8B. Examples of a method for identifying a region where a fingerprint pattern that serves as biometric information is present include a method for identifying a region when the frequency of its image is similar to a fingerprint pattern.

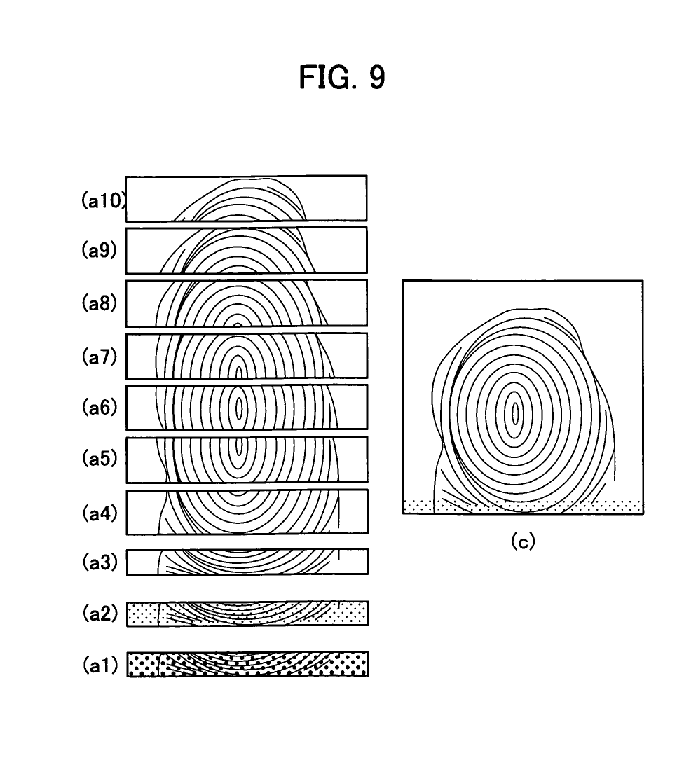

FIG. 9 illustrates partial images (a1) to (a10) that are sequentially obtained by the strip two-dimensional sensor when the finger is moved in the direction 207 shown in FIG. 2 and also illustrates one fingerprint image (c) that is obtained by combining the partial images (a1) to (a10).

In this case, before the partial image (a1) is obtained, the placement of a finger on the sensor is detected in the image-obtaining mode for detecting a finger. The partial images (a1) to (a3) are images obtained in the image-obtaining mode for setting an exposure condition. The partial images (a4) to (a10) are images obtained in the default image-obtaining mode for capturing fingerprint images. In this case, for the three frames, i.e., the partial images (a1) to (a3), the amount of exposure is optimized. The partial images (a1) to (a3) are images obtained by the skipping operation and thus the amount of exposure therefor has not been optimized. The partial images (a1) to (a3), however, are necessary to obtain a large-area image without losing a segment thereof immediately after the start of a finger movement. Further, in order to capture the largest possible area of an image in the most critical center region of a finger with an optimized amount of exposure, it is important to control the LED brightness while obtaining the images (a1) to (a3) at a high speed by the skipping operation.

As described above, in the present embodiment, the control member 123a controls the first, second, and third modes. That is, in the first mode, during relative movement of a finger or subject and the image capture device 104, a plurality of first partial images of the finger are sequentially captured while the exposure condition is varied. In the second mode, in accordance with the plurality of first partial images, an exposure condition is set. In the third mode, in accordance with the set exposure condition, a plurality of second partial images is sequentially captured during relative movement of the finger and the image capture device 104. With this arrangement, an image is obtained immediately after the detection of the finger. This allows for capturing of a large-area image including the start point of a finger movement, thereby making it possible to obtain a larger amount of feature information needed for verification. The present embodiment, therefore, can achieve a high-accuracy fingerprint verification system. Additionally, the present embodiment can increase the likelihood that the verification operation involving a sweep-type sensor specific finger-movement can be completed at a time, thus making it possible to provide a usability-enhanced product.

The present embodiment, which uses a sweep-type sensor, not only can provide a high-accuracy fingerprint verification system, but can also simplify a circuit to thereby achieve a miniaturized circuit. The miniaturization of a processing circuit is preferable for applications requiring portability, including portable apparatuses, such as mobile personal computers, PDAs (personal data assistants), and mobile phones having a transmitter for transmitting information over an electromagnetic wave and a selector for selecting a desired destination.

Although the system for verifying a subject (i.e., authenticating an individual) by using a fingerprint has been described in the above embodiment, the present invention is not limited thereto. For example, the system of the present embodiment is equally applicable to a system for verifying a subject (an individual) by using an eye retina, features of a face, the shape of a palm, and the like, as long as such a system performs the verification based on partial images of the subject. Although the system for verifying a subject performs the verification based on a combined image obtained by connecting partial images of the subject, the present invention is not limited thereto. For example, a sweep-type fingerprint sensor performs verification by comparing the partial image with a pre-registered image without detecting the same fingerprint region among lines of the partial images, and connecting the partial images.

The signal processing apparatus according to the first embodiment of the present invention can capture a full image while setting an exposure condition during a single fingerprint-image-capturing period. This can achieve both high-accuracy verification and high-speed verification.

### Second Embodiment

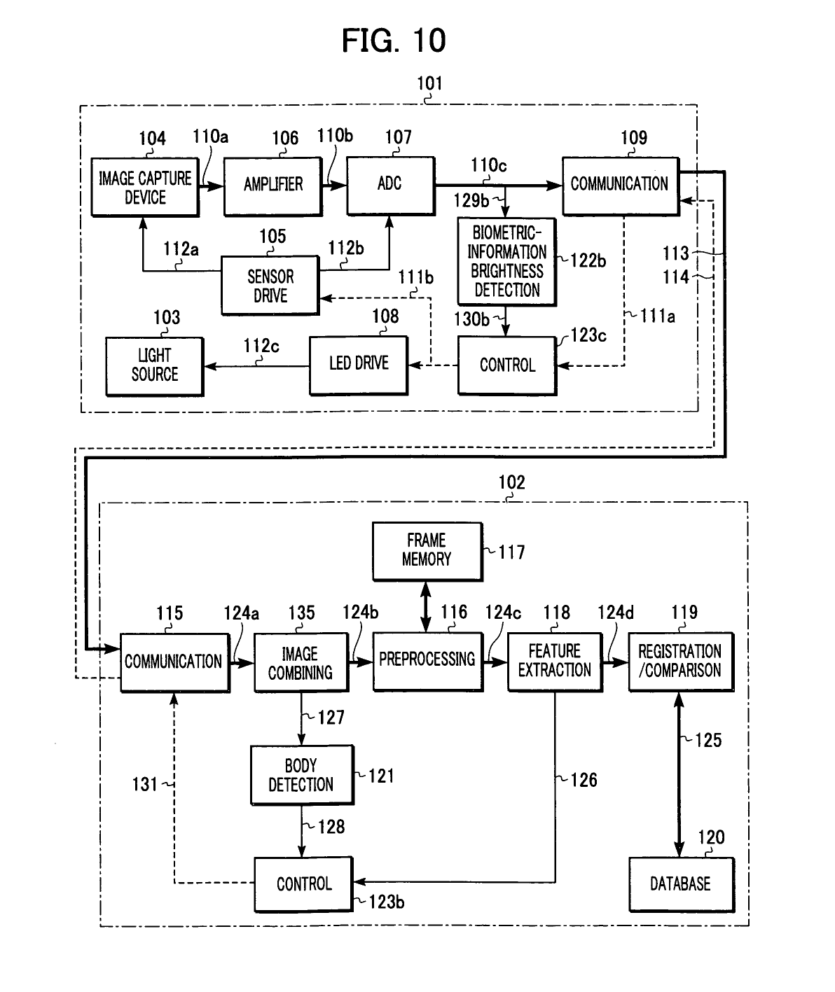

FIG. 10 is a block diagram schematically showing the configuration of a sweep-type (scan type) fingerprint verification apparatus, which serves as a signal processing apparatus, according to a second embodiment of the present invention.

The fingerprint verification apparatus according to the second embodiment includes an image obtaining unit 101 and a verification unit 102, as in the first embodiment.

In the image obtaining unit 101 shown in FIG. 10, an LED 103 serves as a light source (light illuminating member) for illumination. An LED drive 108 is used for controlling the brightness and the illumination timing of the LED 103.

A CMOS or CCD image-capture device 104 may be a one-dimensional sensor or a strip two-dimensional sensor having about five to twenty pixels in the sub-scanning direction. In the present embodiment, the image capture device 104 is a CMOS sensor having 512 pixels in the main-scanning direction and twelve pixels in the sub-scanning direction.

A sensor drive 105 controls the sampling timings of the image capture device 104 and an analog-to-digital converter (ADC) 107. An amplifier 106 clamps an analog output, supplied from the image capture device 104, to a DC level suitable for processing by the ADC 107 at the subsequent stage and appropriately amplifies the analog output.

A biometric-information brightness detection member 122b in the present embodiment identifies a region included in biometric information out of obtained image information and detects the brightness of the identified biometric-information region. A control member 123c controls the sensor drive 105 and the LED drive 108 in response to information sent from the biometric-information brightness detection member 122b and a control signal sent from the verification unit 102.

A drive pulse is sent from the sensor drive 105 to the image capture device 104 via a signal line 112a and a drive pulse is sent from the sensor drive 105 to the ADC 107 via a signal line 112b. A drive pulse is sent from the LED drive 108 to the light source 103 via a signal line 112c. Digital image data is provided to the biometric-information brightness detection member 122b via signal line 129b and the result of biometric-information brightness detection from the biometric-information brightness detection member 122b is provided to control member 123c via signal line 130b. In the present embodiment, a control signal is sent from the verification unit 102 to the image obtaining unit 101 (via control signal line 114) in accordance with a detection signal or the like from a body detection member 121. A communication member 109 in the image obtaining unit 101 receives the control signal via control signal line 114 and forwards it to a control member 123a via control line 111a. The control member 123c controls the sensor drive 105 and the LED drive 108 via control lines 111b.

The image obtaining unit 101 transmits data to the verification unit 102 via a data signal line 113 and receives control signals from the verification unit 102 via a control signal line 114.

A communication member 105 in the verification unit 102 facilitates communications between the verification unit 102 and the image obtaining unit 101 by receiving data signals from the image obtaining unit 101 via data signal line 113 and transmitting control signals to the image obtaining unit 101 via control signal line 114. An image combining member 135 combines images of a subject which are sequentially captured in the sub-scanning direction by the strip two-dimensional sensor.

The body detection member 121 detects the placement of a finger or subject, and determines whether the placed subject is a finger of a living body or a fake finger, by using image information supplied from a preprocessing member 116, which is described below. In response to information sent from the body detection member 121 and other functions (e.g., feature member 118), a control member 123b controls the image obtaining unit 101.

The preprocessing member 116 performs image processing, such as edge enhancement, in order to extract features at a subsequent stage. A frame memory 117 is used to perform image processing. A feature extraction member 118 extracts personal features. A registration/comparison member 119 registers the personal features, which are extracted by the feature extraction member 118, in a database 120 or compares the personal features with registered data for verification.

Image data is transmitted from communication member 115 to image combining member 135 via data line 124a, from image combining member 135 to preprocessing member 116 via data line 124b, from preprocessing member 116 to feature extraction member 118 via data line 124c and from feature extraction member 118 to registration/comparison member 119 via data line 124d. The communications between the registration/comparison member 119 and the database 120 are accomplished via data and control line 125. An extraction state of the feature extraction member 118 is transmitted via signal line 126 to control member 123b, and necessary image information is sent from the image combining member 135 to the body detection member 121 via signal line 127. The result of body detection is transmitted from the body detection member 121 to control member 123b via signal line 128. The control member 123b transmits a signal for controlling the image obtaining unit 101 to communication module 115 via signal line 131 in response states of other functions (e.g., states of body detection member 121 and feature extraction member 118).

The fingerprint verification apparatus of the present embodiment obtains a fingerprint image while setting an optimum image-capturing condition, by switching the driving of the sensor and the LED, during an image-capturing operation for scanning a finger or subject. Specifically, to achieve this switching, the sensor drive 105 and the LED drive 108 in the image obtaining unit 101 are controlled in response to finger-detection information sent from the verification unit 102 and a biometric-information region brightness detection result sent from the image-obtaining unit 101.

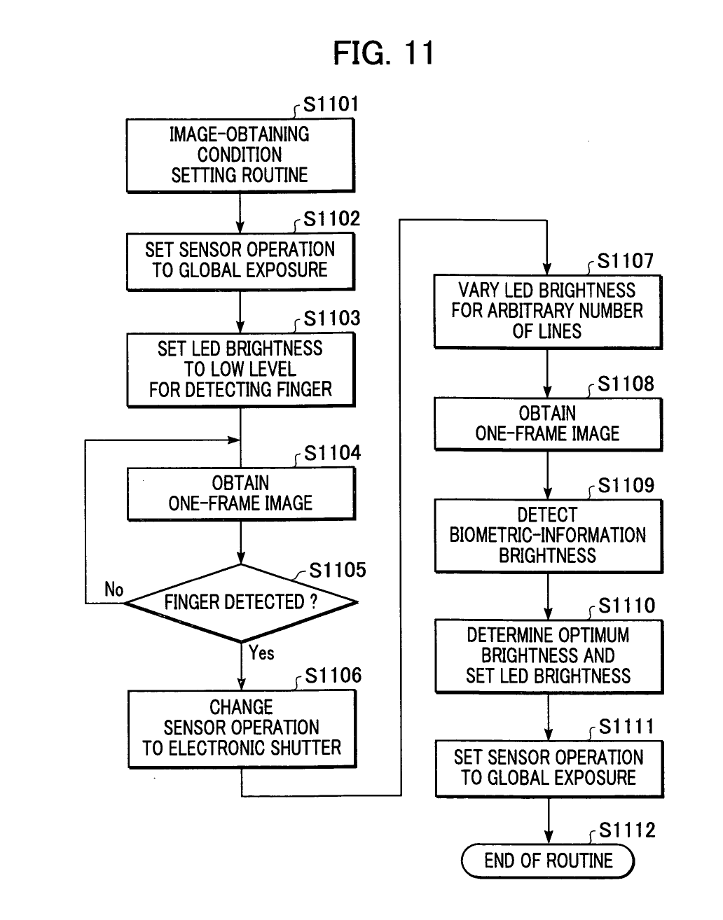

The operation of the present embodiment will now be described with reference to FIGS. 11 to 13.

FIG. 11 is a flow chart depicting an image-obtaining condition setting routine for the fingerprint verification apparatus of the present embodiment. In the routine described below, the sensor drive 105 and the LED drive 108 are controlled in accordance with finger information detected by the verification unit 102 serving as a main system and biometric brightness-information detected by the image obtaining unit 101, thereby setting an image obtaining condition for the image obtaining unit 101.

In step S1101, the process enters an image-obtaining condition setting routine. In step S1102, the control member 123c controls the sensor drive 105 to set the exposure operation of the sensor to a global exposure mode.

In step S1103, the control member 123c controls the LED drive 108 to set the LED brightness to a low level that is sufficient to detect the presence/absence of a finger. Thus, the sensor is put into an image-obtaining mode for detecting a finger.

In step S1104, a one-frame partial image is obtained. In step S1105, a determination is made as to whether finger-detection information is received from the verification unit 102. When a finger is not detected, i.e., finger-detection information is not received (no in step S1105), the process returns to step S1104. When a finger is detected (yes in step S1105), the process proceeds to step S1106.

In step S1106, the control member 123c controls the sensor drive 105 to change the exposure operation of the sensor to an exposure mode using the rolling shutter system (an electronic shutter system).

In step S1107, the control member 123c controls the LED drive 108 to cause the LED brightness to vary for an arbitrary number of lines in synchronization with the operation of the electronic shutter. Examples of a method for varying the LED brightness include a method for controlling current flowing in the LED and a method for changing the rate of the LED illumination period (including driving the LED in a pulsed manner). As a result of the processing in step S1107, the sensor is put into an image-obtaining mode for setting an exposure condition.

In this mode, in step S1108, a partial image for only one frame is obtained. In step S1109, the output levels of a region including biometric information, i.e., the output levels of a fingerprint region, are detected for the arbitrary number of lines for which the LED brightness has changed. In step S1110, output levels are detected and the control member 123c determines an LED brightness value for the output level that is determined to be most appropriate for verification processing, and controls the LED drive 108 so that the LED brightness value reaches the determined value.

In step S1111, the control member 123c controls the sensor drive 105 to change the exposure operation of the sensor again to the global exposure mode. As a result, with the exposure condition being set to an optimum value, the sensor is put into the default image-obtaining mode for capturing fingerprint images. In step S1112, the image-obtaining condition setting routine ends.

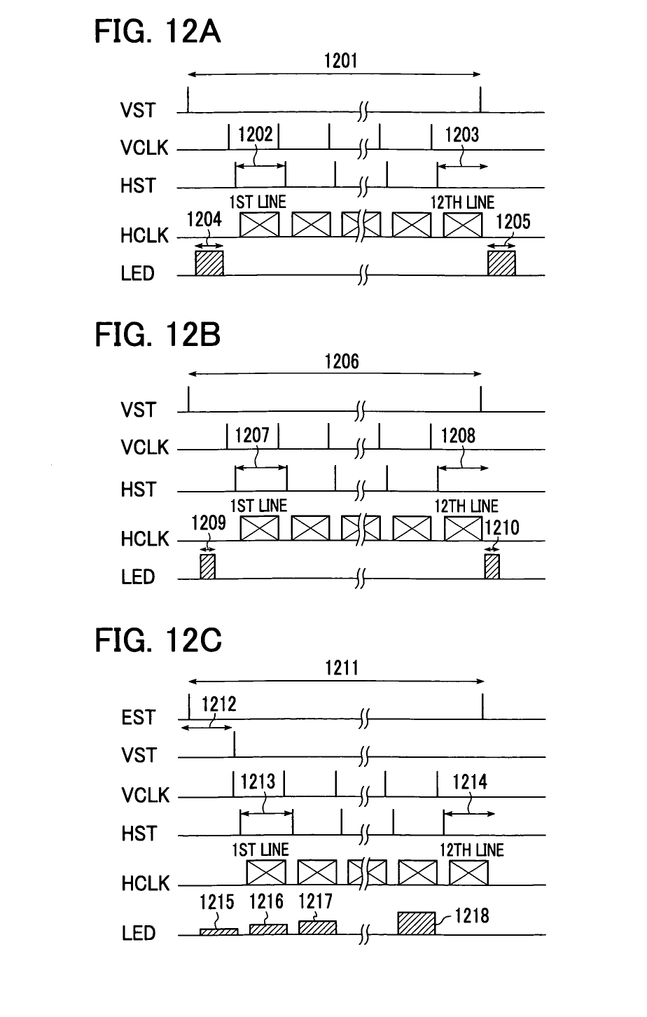

FIG. 12A shows the operation timings of the sensor and the LED for the default image-obtaining mode for capturing fingerprint images, FIG. 12B shows the operation timings of the sensor and the LED for the image-obtaining mode for detecting a finger, and FIG. 12C shows the operation timings of the sensor and the LED for the image-obtaining mode for setting an exposure condition.

Shown in FIGS. 12A to 12C are VST and VCLK which indicate a start pulse and a transfer clock pulse, respectively, for the vertical shift register (VSR) 59 in the sensor sub-scanning direction (the vertical scanning direction, i.e., the same direction as the finger movement direction in the present embodiment). HST and HCLK indicate a start pulse and a transfer clock pulse, respectively, for the horizontal shift register (HSR) 56 in the sensor main-scanning direction (the horizontal scanning direction, i.e., a direction substantially perpendicular to the finger movement direction in the present embodiment). LED indicates an LED illumination pulse. The horizontal axis indicates an illumination period. As denoted by “x”, small clock pulses HCLK are present at a certain cycle.

In the default image-obtaining mode (FIG. 12A) for capturing a fingerprint image, one partial image is obtained in a one-frame period 1201. An image for one line in the main-scanning direction is obtained in a period 1202, 1203. Specifically, in the period 1202, an image for the first line is transferred, and, in the period 1203, an image for the twelfth line is transferred. An LED illumination period 1204 defines the amount of exposure for a one-frame image obtained and output in the period 1201. An LED illumination period 1205 defines the amount of exposure for a one-frame image obtained and output in a period subsequent to the period 1201. In the image-obtaining mode for capturing fingerprint images after the optimization of the amount of exposure, images are captured with a fixed amount of LED illumination, as indicated by the periods 1204 and 1205. The exposure by the LED being lit in the period 1204 is referred to as “global exposure”, since the exposure defines the amount of exposure for the entire twelve lines in the sensor, images for the lines being output in the period 1201.

In the image-obtaining mode (FIG. 12B) for detecting a finger, a one-frame period 1206 for obtaining one partial image is shown. Also shown are periods in which an image for one line in the main-scanning direction is obtained 1207, 1208. In the period 1207, an image for the first line is transferred, and, in the period 1208, an image output to the twelfth line is transferred. An LED illumination period 1209 defines the amount of exposure for a one-frame image obtained and output in the period 1206. An LED illumination period 1210 defines the amount of exposure for a one-frame image obtained and output in a period subsequent to the period 1206. In the image-obtaining mode for detecting a finger, it is sufficient for the LED to allow detection of the presence/absence of a finger, so that the illumination period is set to a minimum length, as indicated by the periods 1209 and 1210, In this mode as well, the exposure by the LED being lit in the period 1209 defines the amount of exposure for the entire twelve lines in the sensor, images for the lines being output in the period 1206, and is thus referred to as “global exposure”.

In the image-obtaining mode (FIG. 12C) for setting an exposure condition, a one-frame period 1211 for obtaining one partial image is shown. Also shown in FIG. 12C is a start pulse EST for the shift register (ESR) 62 for the above-noted electronic shutter. A rolling-shutter exposure time 1212 is defined by the interval between the start pulse EST and the start pulse VST. Each line is exposed during an exposure time immediately before the transfer clock pulse VCLK, by which the line is selected, is supplied thereto. Periods 1213 and 1214 in which an image for one line in the main-scanning direction is obtained are shown. In the period 1213, an image for the first line is transferred, and, in the period 1214, an image output to the twelfth line is transferred. An LED illumination period 1215 defines the amount of exposure for a one-line image obtained and output in the period 1213. An LED illumination period 1218 defines the amount of exposure for a one-line image obtained and output in the period 1214. In the image-obtaining mode for setting an exposure condition, one image is obtained while the LED illumination brightness is varied in multiple levels, as indicated by the periods 1215 to 1218. In this manner, one image is captured with multiple different levels of exposure conditions, and the use of the image allows the determination of an optimum exposure condition.

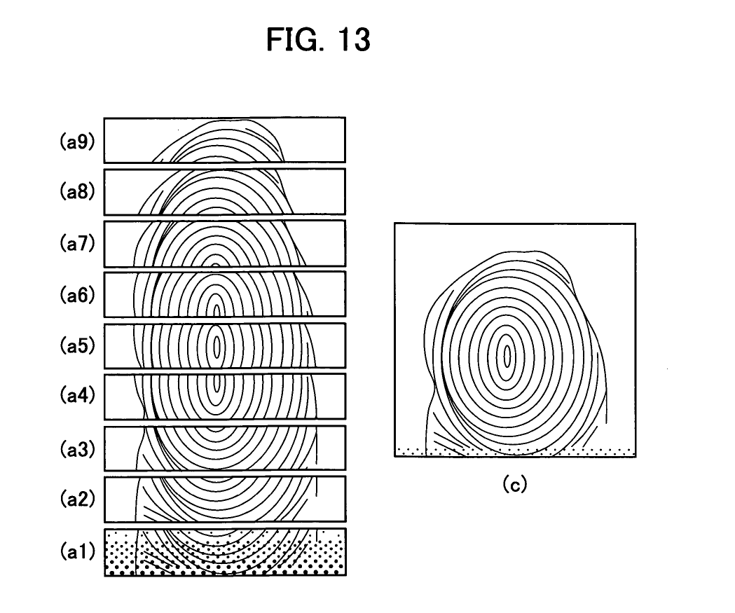

Referring to FIG. 13, images (a1) to (a9) are partial images of a finger which are sequentially obtained by the strip two-dimensional sensor when the finger is moved in the direction 207 shown in FIG. 2A. An image (c) is one fingerprint image obtained by combination of the partial images (a1) to (a9).

In this case, before the partial image (a1) is obtained, the placement of a finger on the sensor is detected in the image-obtaining mode for detecting a finger. The partial image (a1) is an image obtained in the image-obtaining mode for setting an exposure condition. The partial images (a2) to (a9) are images obtained in the default image-obtaining mode for capturing fingerprint images. In this case, the amount of exposure is optimized using one frame (a1). The partial image (a1) is an image obtained with the varied amount of exposure within the surface of the partial image. The partial image (a1) is also necessary to obtain a large-area image without losing a segment thereof immediately after the start of a finger movement. This arrangement has an advantage in that an optimum exposure condition can be set with only one partial image (a1) in order to capture the largest possible area of an image in the most critical center region of a finger with an optimized amount of exposure.

As described above, the control member 123a in the present embodiment controls the first, second, and third modes. That is, in the first mode, during relative movement of a finger or subject and the image capture device 104 for capturing partial images (fingerprints) of the finger, a first partial image of the finger is captured with a plurality of exposure conditions. In the second mode, in accordance with the first partial image, an exposure condition is set. In the third mode, in accordance with the set exposure condition, a plurality of second partial images is sequentially captured during relative movement of the finger and the image capture device 104. With this arrangement, an image is obtained immediately after the detection of the finger. This allows for capturing of a large-area image including the start point of a finger movement, thereby making it possible to obtain a larger amount of feature information needed for verification. The present embodiment, therefore, can achieve a high-accuracy fingerprint verification system. Additionally, the present embodiment can increase the likelihood that the verification operation involving a sweep-type sensor specific finger-movement can be completed at a time, thus making it possible to provide a usability-enhanced product.

The present embodiment, which uses a sweep-type sensor, not only can provide a high-accuracy fingerprint verification system, but also can simplify a circuit to thereby achieve a miniaturized circuit. The miniaturization of a processing circuit is preferable for applications requiring portability, including portable apparatuses, such as mobile personal computers, PDAs (personal data assistants), and mobile phones having a transmitter for transmitting information over an electromagnetic wave and a selector for selecting a desired destination. Although the system for verifying a subject (i.e., authenticating an individual) by using a fingerprint has been described in the above embodiment, the present invention is not limited thereto. For example, the system of the present embodiment is equally applicable to a system for verifying a subject (an individual) by using an eye retina, features of a face, the shape of a palm, and the like, as long as such a system performs the verification based on a combined image obtained by connecting partial images of the subject.

### Third Embodiment

In the first and second embodiments described above, the descriptions have been given of a case in which the amount of exposure is controlled at an initial stage of sequentially obtaining partial images. In the third embodiment, however, a description will be given of an example in which the amount of exposure is controlled in response to a change in brightness in the middle of sequentially obtaining partial images.

First, problems of sweep-type fingerprint sensors will be described. For example, for a contact-optical sweep-type fingerprint sensor, a finger is moved in such a manner that it is rubbed against the sensor surface while being closely contacted therewith. This makes it difficult to maintain the speed and the pressure of the finger and the manner of placing the finger from the beginning of the finger movement to the end thereof, and, in practice, they often vary.

Further, for a fingerprint sensor installed on a mobile apparatus, such as a portable telephone, PDA, or notebook computer, the way in which external light is incident on the sensor may vary when a person moves in a vehicle or on foot, for example, from a place in direct sunshine to a place in the shade or from outdoors to indoors, when an image is captured during the movement of a finger. Additionally, while the finger is being moved, the condition of a finger surface may vary because of an increase in the amount of sweat.

In such cases, light is diffused, reflected, or absorbed by the finger and the amount of light incident on the image capture device varies, thus leading to a problem in that the amount of charge stored greatly changes. Further, a finger-thickness variation depending on finger sections (e.g., the top joint and the tip of a finger) and a difference depending on regions, such as regions including bone or nail, may cause the amount of exposure to vary. When the amount of exposure and the amount of charge stored vary greatly due to such factors in the middle of sequentially obtaining partial images, the sweep-type fingerprint sensor fails in image-combining processing (image-reconstruction processing) for connecting the partial images, thereby making it impossible to connect them or providing an incorrectly-connected image.

This is because the image-combining processing involves calculating a correlation coefficient between sequentially-captured partial images, detecting the same fingerprint region among lines of the partial images, and connecting the partial images such that the detected lines are superimposed. When the brightness varies during a finger movement, a correlation between the corresponding lines decreases even though they belong to the same finger region. As a result, it is incorrectly determined that the lines do not belong to the same fingerprint region or even belong to other different regions. When the image-combining processing fails in such a manner, a segment of the entire fingerprint image is lost or a stretched or a shrunken image is provided. As a result, the matching rate of extracted features to registered fingerprint features declines, so that the matching accuracy decreases.

Also, when the amount of charge stored greatly varies in the middle of sequentially obtaining partial images, the contrast and brightness within the surface of an entire fingerprint image obtained vary. Consequently, feature information to be compared with a registered image also varies. Thus, even when any comparing system, such as a feature-point extraction system, pattern matching system, or frequency analysis system, is used, a correlation between an obtained image and a reference image decreases, so that the comparison accuracy decreases. This is a common assignment of one sweep-type fingerprint sensor which performs image-combining processing (which is also referred to as “image reconstruction processing”), which involves determining a correlation coefficient between sequentially-captured partial images by computation, detecting the same fingerprint region among lines of the partial images, and connecting the partial images and another sweep-type fingerprint sensor which performs verification by comparing the partial image with a pre-registered image without detecting the same fingerprint region among lines of the partial images, and connecting the partial images.

For example, when a finger is moved toward you while being pressed against the sensor surface, the resulting image of the finger tip has a brightness about 10% to 20% higher than the image of vicinity of the finger top joint. This is because a pressing pressure in the vicinity of the finger top joint is so high since the finger in that vicinity moves in parallel to the sensor surface, whereas the force of the finger tip tends to be applied downward due to the finger's pressure being applied in a perpendicular direction to the sensor surface. For example, in the middle of obtaining successive partial images, when the brightness of a partial image is increased by as much as 20% relative to another partial image, increasing the gain using automatic gain control (AGC) by a factor of, for example, four provides a fourfold increase. Thus, in such a case, there is a problem in that an image signal that has been within a dynamic range is saturated. When an image signal is saturated, an appropriate fingerprint image cannot be obtained, thereby making it impossible to extract a correlated portion between partial images and to combine the partial images. Accordingly, a reduction in brightness variation is important.

To overcome the above-described problems, the fingerprint verification apparatus of the present embodiment controls a charge-storage condition for each partial image so as to compensate for a varying charge-storage state. Specifically, for example, a brightness variation due to a change in a finger's pressing pressure and a brightness variation due to a change in an environmental factor are identified independently from a fingerprint pattern, and the amount of exposure, which is defined by the brightness of the light source and the storage time of the image capture device, is controlled for each partial image such that a desired amount of exposure is provided.

Next, a description is given of a brightness change resulting from a difference in the way of pressing a finger against the sensor surface. When light is incident on the interface of material having a different refractive index, the light reflects at the interface. For example, such reflection occurs when light that has passed through the air having a refractive index of 1 reaches the surface of glass or the like. The reflection coefficient R in such a case can be calculated using the following equation:

R=((1−n1)/(1+n1) )²

where n1 indicates the refractive index of a material, such as glass. In this case, where n1=1.5, R=0.04 which means that when the refractive index of a material is 1.5, about 4% of light is reflected.

Now, the interface between the finger and the sensor surface will be discussed. The sensor surface is provided with a protecting member and/or an optical member, such as silicon and/or glass. The refractive indices of such materials are approximately 1.4 to 1.6. Also, while dependent on the influence of sweat on a finger surface, the refractive index of a finger has been empirically known to be approximately 1.4 to 1.6. Now, the relationship of the light source, the finger, and the sensor surface will be discussed. With regard to the finger, there would be a case in which the finger is in light contact with the sensor and a case in which the finger is strongly pressed against the sensor. In either case, possible optical paths through which external light travels to the finger are: (1) the interface between the LED surface and the air; and (2) the interface between the air and the finger surface. Possible optical paths through which light is dispersed on the finger, is emitted therefrom, and is incident on the sensor are: (3) the interface between the finger and the air; and (4) the interface between the air and the sensor.

When the light source and the finger are in light contact with each other and also the finger and the sensor are in light contact with each other, air gaps exist therebetween, so that about 2.6% to 5.3% of light is lost at each of the interfaces (1) to (4). Thus, a total of about 10% to 21% of light is lost. On the other hand, when the finger is in close contact with the sensor or the light source, light is not reflected by either (1) and (2) or (3) and (4), so that the amount of reflection is reduced by one-half and the total loss of light becomes approximately 5% to 11%. When the finger is in close contact with both the sensor and the light source, no light is reflected at any of the interfaces (1) to (4), so that no loss occurs. Thus, the resulting brightness varies by about 10% to 21%, depending upon a pressing-pressure change due to a finger movement. For each level (for the interfaces (1) to (4)), the brightness varies by 2.6% to 5.3%.

Thus, for a given sensor unit, a one-level change, which is associated with a refractive index defined by the material of the light source and the sensor surface, is uniquely determined to be a value in the range of 2.6% to 5.3%. Accordingly, changing the brightness in multiple levels, each being an integer multiple of that value, makes it possible to deal with a brightness change during a finger movement, when considering the fact that a brightness change due to a pressing pressure is a major factor during a finger movement.

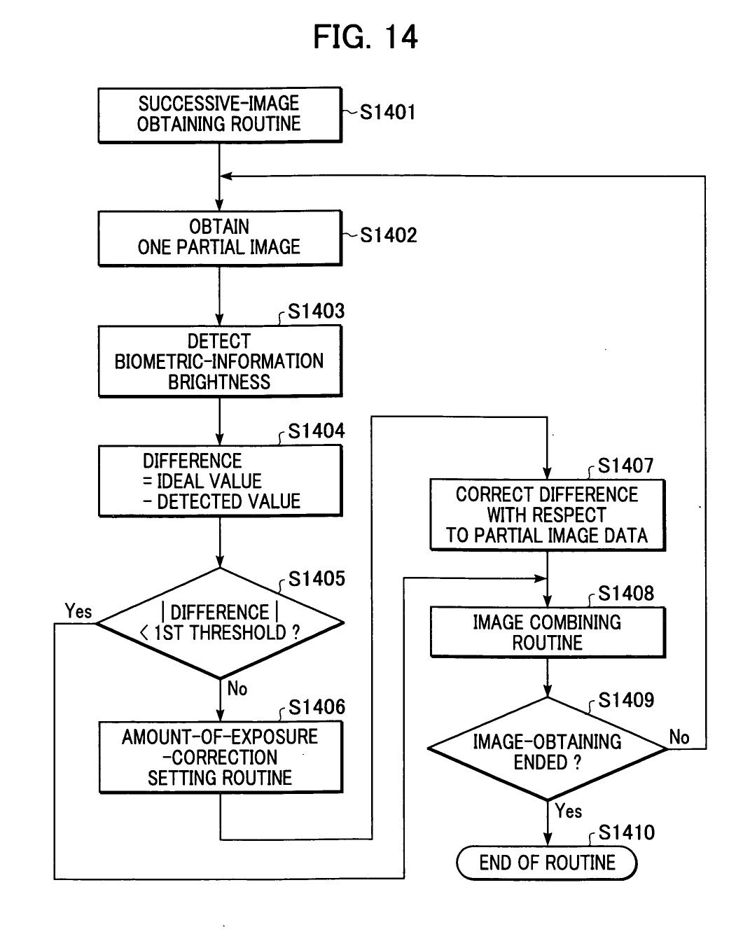

Now, a description is given of an example in which one level of brightness change due to a refractive index is set to 4% in the present embodiment and the brightness is varied with an integer multiple of 4%. The operation of the third embodiment will now be described with reference to FIGS. 14 to 20B. Since the configuration of the fingerprint verification apparatus of the third embodiment is the same as that of the fingerprint verification apparatus of the first embodiment illustrated in FIG. 1, the description thereof is omitted.

As in the fingerprint verification apparatus of the first embodiment, in the fingerprint verification apparatus of the third embodiment, in accordance with detected biometric brightness-information, the verification unit 102 controls the sensor drive 105 to change the charge-storage period and/or controls the LED drive 108 to change the LED illumination period and/or the LED brightness, thereby changing the exposure condition of the image obtaining unit 101 for each partial image.

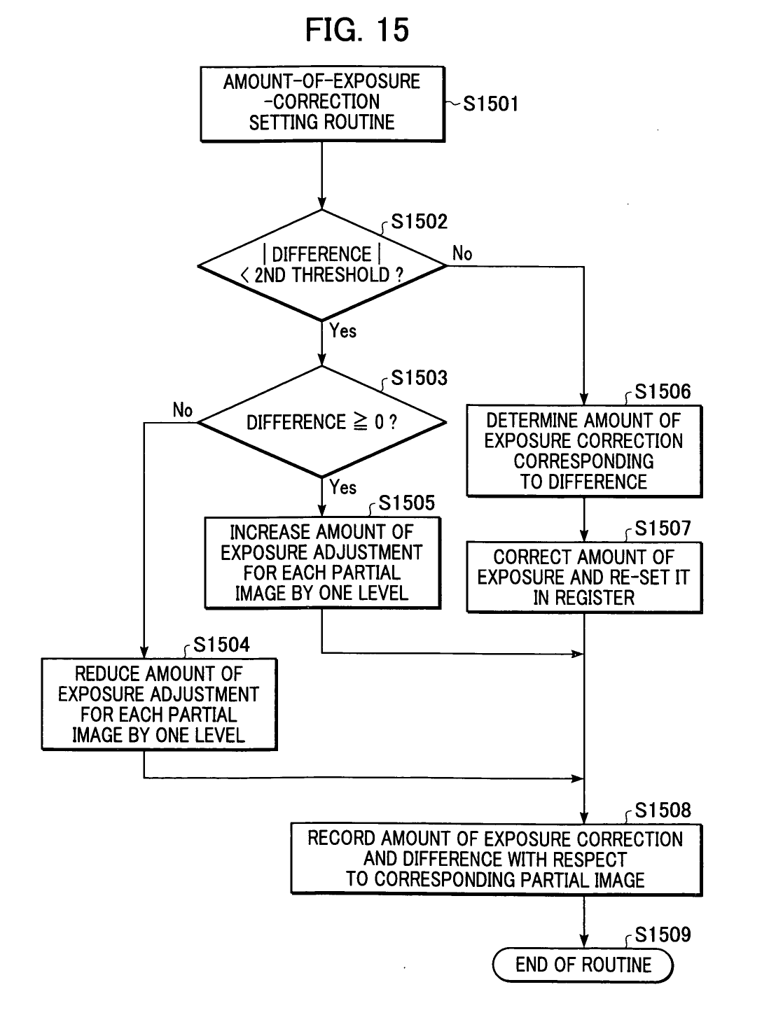

FIG. 14 is a flow chart showing the operation of a successive-image obtaining routine for the fingerprint verification apparatus of the present embodiment illustrated in FIG. 1. Referring to FIG. 14, in step S1401, the fingerprint verification apparatus starts a successive-image obtaining condition setting routine. In step S1402, the verification unit 102 receives one partial image from the image obtaining unit 101. Next, in step S1403, the biometric-information brightness detection member 122a detects a biometric-information brightness. In step S1404, the control member 123a calculates a difference between the detected brightness and an ideal brightness value that has been set in advance. In step S1405, the control member 123a determines whether or not the absolute value of the calculated difference is less than a first pre-set threshold. When it is determined that the absolute value of the difference is less than the first pre-set threshold, this indicates that the variation in brightness is small, and, in the image combining routine in step S1408, the image combining member 135 performs processing for connecting the obtained partial image with another partial image. On the other hand, when it is determined in step S1405 that the absolute value of the difference is greater than or equal to the first pre-set threshold, the process proceeds to an amount-of-exposure-correction setting routine in step S1406. In step S1406, the control member 123a controls the sensor drive 105 and the LED drive 108 to determine the amount of correction for controlling the amount of exposure. Details of the amount-of-exposure-correction routine (step S1406) are shown in FIG. 15 and described later.

Since the correction of the amount of exposure in this case is reflected in the next exposure, partial images that have already been captured may have a large difference between the brightness and the ideal value. Thus, if no further measure is taken, the accuracy of combining images and the accuracy of comparing images will decrease. Thus, in step S1407, the image combining member 135 performs processing for correcting the difference with respect to the partial image before being combined so as to eliminate the difference. Examples of available methods for correcting a difference with respect to a partial image before being combined include a method in which the difference is merely subtracted across the board from image data and a method in which multiplication is performed such that the image data is multiplied by a gain corresponding to the rate of a brightness decrease (since brightness corresponding to the difference has been reduced).

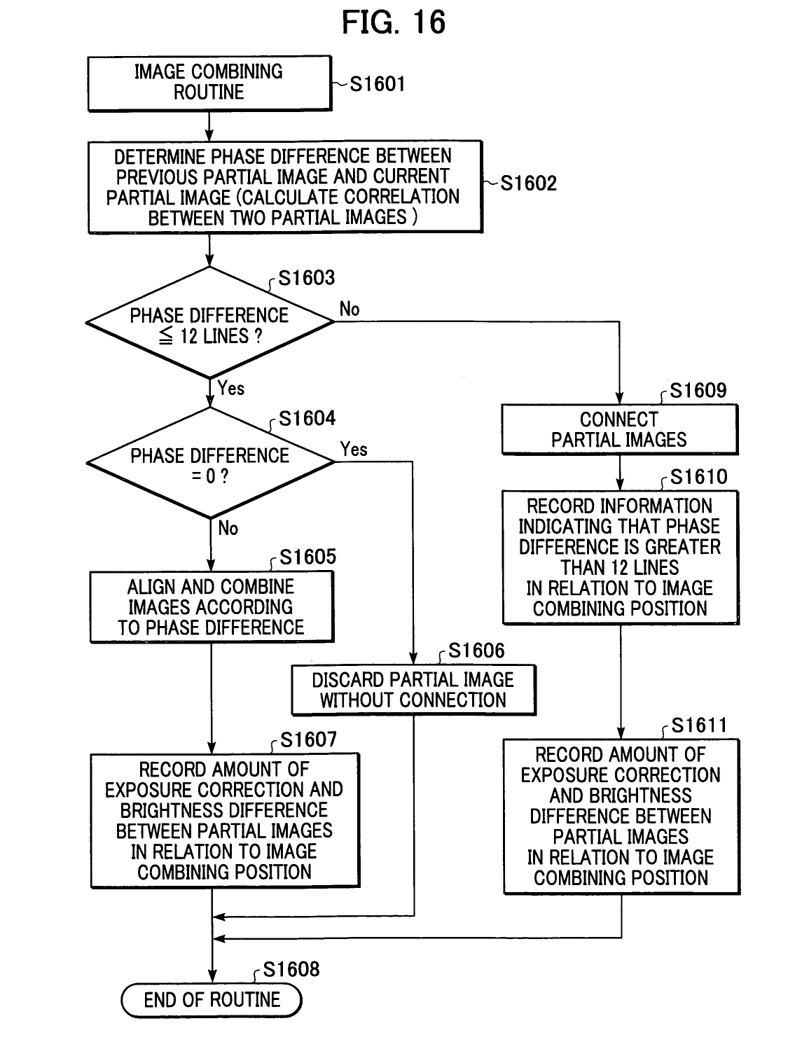

After the correction control for the amount of exposure (step S1406) and the correction processing for the partial image (step S1407) are performed as described above, in the image combining routine in step S1408, the image combining member 135 connects the partial image with the previous partial image. The detailed processing in the image-combing routine in step S1408 is shown in FIG. 16 and described later. Next, in step S1409, the control member 123a determines whether or not to finish the sequential obtaining of partial images. When it is determined that image-obtaining has not ended, i.e., the sequential obtaining of partial images is not finished (no in step S1409), the process returns to step S1402 in which the next partial image is obtained. On the other hand, when it is determined that image-obtaining has ended, i.e., the sequential obtaining of partial images is finished, (yes in step S1409), the successive-image obtaining routine ends in step S1410.

In sweep-type sensors, the capability of tracking a finger moving at a high speed is one indicator of verification performance. This is because it is important to improve the trackability since the way of moving the finger varies from person to person and the speed often increases or decreases because of the difficulty of moving the finger at a constant speed. Typically, sweep-type sensors capture partial images at a high speed. Thus, in the case of a low movement speed, since the amount of movement across partial images is small, the sensors combine the partial images while thinning out some of them. On the other hand, in the case of a high movement speed, since the areas of regions that can be correlated between adjacent partial images are reduced, thinning out even one partial image makes it impossible to correlate the previous and next images of the that image, resulting in an interrupted connection of the images. It is therefore important to use sequentially-obtained partial images while minimizing waste. In the fingerprint verification apparatus of the present embodiment, in accordance with a detection result output from the biometric-information brightness detection member 122a, the amount of exposure for a subsequent partial image is controlled, and partial images whose brightness changes are detected and are subjected to correction processing, and then the resulting images are combined. This arrangement improves the comparison accuracy and the verification speed.

The amount-of-exposure-correction setting routine performed at step S1406 shown in FIG. 14 will now be described. FIG. 15 is a flow chart showing the details of the exposure-correction-amount setting routine S1406 shown in FIG. 14. As shown in FIG. 15, first, in step S1501, the process enters the amount-of-exposure-correction setting routine. Next, in step S1502, the control member 123a compares the absolute value of the difference, which is obtained by comparing the detected biometric brightness with the above-noted ideal value (in step S1404), with a second pre-set threshold. When it is determined in step S1502 that the absolute value of the difference is less than the second threshold, this indicates that the brightness has varied due to a change in the pressing pressure, and the process proceeds to step S1503. On the other hand, when it is determined in step S1502 that the absolute value of the difference is greater than or equal to the second threshold, this indicates a change in some environment factor, such as external light, and the process proceeds to step S1506.

In step S1503, when it is determined that the difference is less than “0”, the process proceeds to step S1504. In this case, since the brightness is greater than the ideal value, the control member 123a performs adjustment for reducing a pre-set amount of exposure adjustment by one level. On the other hand, when it is determined in step S1503 that the difference is greater than or equal to “0”, the process proceeds to step S1505. In this case, since the brightness is lower than the ideal value, the control member 123a performs adjustment for increasing the pre-set amount of exposure adjustment by one level. This adjustment of the amount of exposure is achieved by increasing/reducing a set value stored in an exposure-control register by a predetermined value (i.e., one level). This register may be a register for setting the charge-storage period of the sensor drive 105 and/or a register for setting the LED illumination period or the LED brightness of the LED drive 108. In this case, however, the set value after the change becomes effective in the next exposure period.

As described above, the amount of brightness change resulting from the finger's pressing pressure can be pre-set to one of multiple levels. That is, this arrangement is adapted to perform correction so as to correspond to a characteristic of a change, by varying, for each partial image, the amount of one-level change in exposure corresponding to the amount of change in reflection coefficient. Since the amount of exposure is varied in accordance with a pre-set rate of change, this arrangement provides advantages in that the amount of exposure is readily changed so as to correspond to an actual brightness change, therefore, an optimum exposure is quickly reached.

On the other hand, when the process proceeds to step S1506, this means that a threshold has significantly changed and it is determined that this case requires an emergency measure. Since such a significant change is caused by various factors, it is impossible to determine the amount of correction in advance. Thus, this arrangement is adapted to determine a correction value for each case and to change the amount of exposure all at once during the next exposure. Specifically, in step S1506, the control member 123a determines an exposure control set-value (the amount of exposure correction) needed to correct an amount corresponding to the detected difference. Next, in step S1507, the control member 123a re-sets the exposure-control register (the register for setting the charge-storage period of the sensor drive 105 and/or the register for the LED illumination period or the LED brightness of the LED drive 108). The setting in this case, however, becomes effective in the next exposure period.

As described above, after controlling the amount of exposure by determining the type of each brightness change or setting the type in advance, in step S1508, the control member 123a stores, in a memory, a difference with respect to the corresponding partial image and the amount of exposure associated with the partial images. In step S1509, the exposure-correction-amount setting routine ends.

Next, the image combining routine (performed at step S1408 in FIG. 14) will be described in detail.

FIG. 16 is a flow chart depicting the details of the image combining routine performed at step S1408 shown in FIG. 14. As shown in FIG. 16, first, in step S1601, the process enters the image combining routine. In step S1602, the image combining member 135 determines a phase difference between the previous partial image and the current partial image. The phase difference between partial images herein refers to the amount of displacement between two partial images with respect to the same region of a finger, the displacement being caused by relative movement of the finger. Upon detecting the phase difference between the two partial images, the image combining member 135 aligns the partial images. In this case, the image combining member 135 determines the phase difference between the two partial images, using a method for calculating a correlation between partial images. Examples of a method for calculating the correlation include a method for calculating a cross-correlation coefficient between two partial images, a method for determining the absolute value of a difference in pixel brightness between two partial images, a method for detecting a value at which two partial images match through the cross power spectrum using Fast Fourier Transform, and a method for extracting respective feature points of two partial images and aligning the partial images such that the feature points match each other.

Next, in step S1603, the image combining member 135 determines whether or not the phase difference between the two partial images is not greater than twelve lines (twelve pixels). When it is determined that the phase difference is not greater than twelve lines, this indicates that the phase difference between the partial images has been detected. While the image capture device 104 has twelve lines in the finger movement direction (i.e., in the sub-scanning direction of the image capture device 104) in the present embodiment, the present invention is not limited thereto. In step S1604, the image combining member 135 determines whether or not the phase difference is “0”. When it is determined that the phase difference is “0”, this indicates that the finger has not moved at all or the finger has moved at a significantly low speed, and the process proceeds to step S1606, in which the image combining member 135 discards the current partial image without connecting it with the previous partial image. Next, the process proceeds to step S1608, in which the image combining member 135 ends the image combining routine. In this case, the previous partial image is used for determining a phase difference with respect to a partial image to be subsequently obtained and/or for processing for combining images.

When it is determined in step S1604 that the phase difference is not “0”, the process proceeds to step S1605, in which the image combining member 135 aligns the two partial images in accordance with the detected phase difference and combines the obtained partial image with the previous partial image. Next, in step S1607, in relation to positions of the corresponding partial images in the combined image, the image combining member 135 records the brightness difference, the amount of exposure correction, and the connection result of the partial images in a separate file from the images. For example, this file is used, when the registration/comparison member 119 compares the combined image of an entire fingerprint with registered fingerprint data by assigning weights to feature points located in individual regions of partial images, while considering a sweep-type specific quality difference for each partial image. For example, the arrangement may be such that a partial image having a large brightness difference and/or a large amount of exposure correction is determined to have a large amount of error and is not used for comparison. This makes it possible to enhance the verification accuracy, thereby allowing an improvement in accuracy of comparing a fingerprint.

On the other hand, when it is determined in step S1603 that the phase difference between the two partial images is greater than twelve lines or when no value is obtained, this indicates that no correlation was found between the partial images. In such a case, a movement that was too fast can be responsible for that result, in step S1609, the image combining member 135 connects the first line of the current partial image with the last line of the previous partial image, rather than discarding the obtained partial image. Next, in step S1610, the image combining member 135 records, in the above-noted file or the like, information indicating that the phase difference is greater than twelve lines, in relation to positions of the partial images in the combined image. Next, in step S1611, the image combining member 135 records, in the above-described file or the like, the amount of exposure correction and the brightness difference between the partial images, in relation to positions of the corresponding partial images in the combined image.

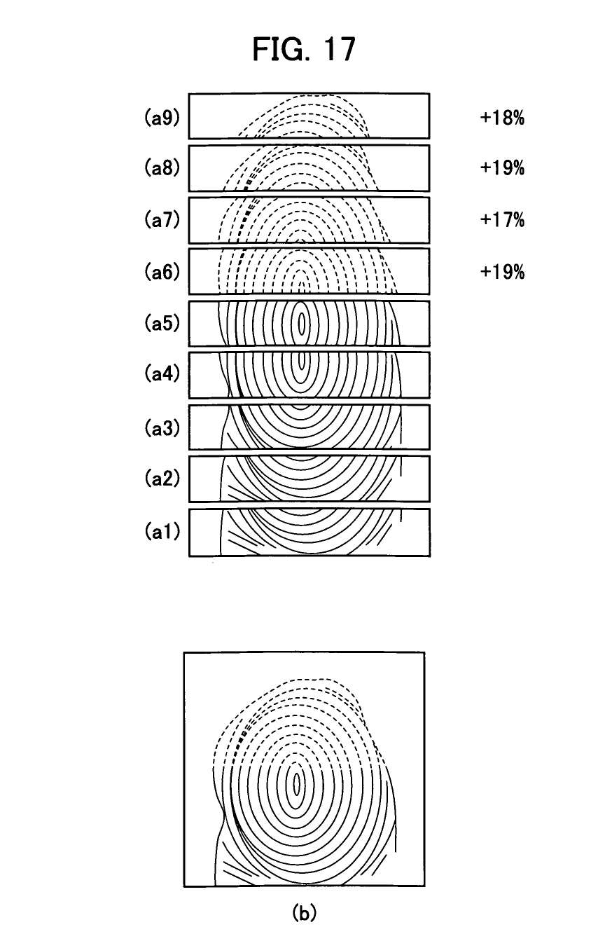

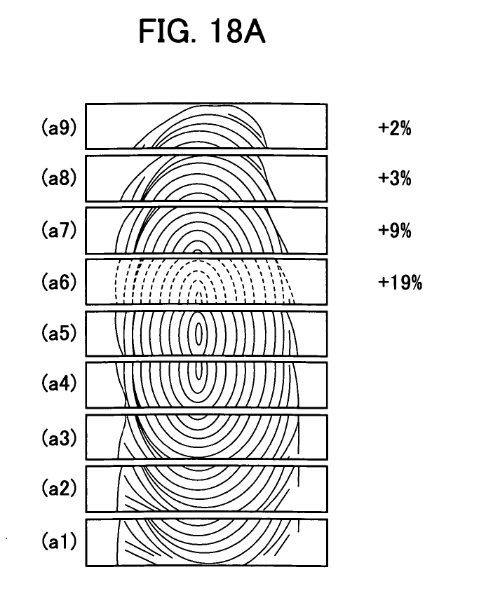

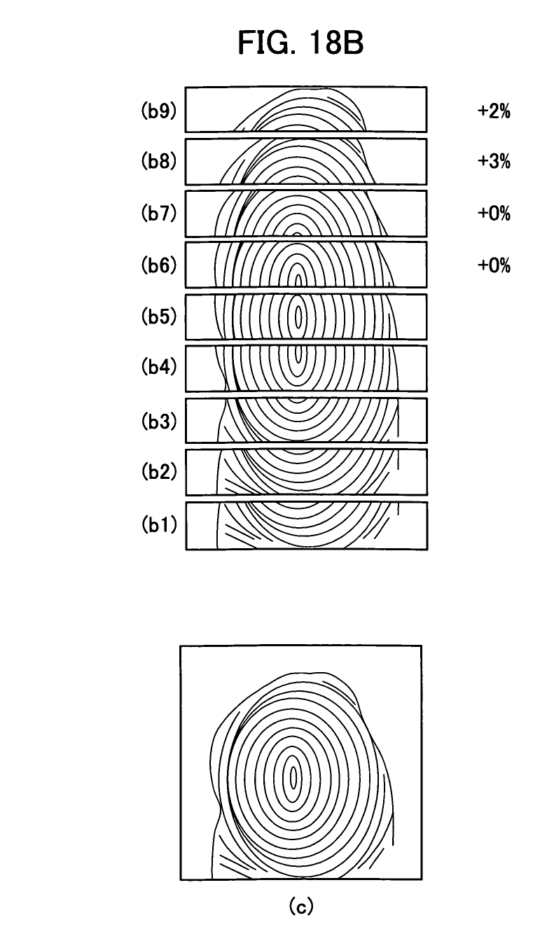

Effects of processing performed by the fingerprint verification apparatus of the present embodiment in response to a brightness change resulting from a change in a finger's pressing pressure will now be described with reference to FIGS. 17, 18A and 18B.

FIG. 17 is a schematic view showing exemplary partial images (a1) to (a9) that are obtained by a known method in which no exposure control is performed in response to a change in the finger's pressing pressure. FIG. 17 also shows an exemplarily fingerprint image (b) that is obtained by combination of the partial images (a1) to (a9). FIG. 18A is a schematic view showing exemplary partial images (a1) to (a9) that are obtained when the fingerprint verification apparatus of the present embodiment performs exposure control in response to a brightness change due to a change in the finger's pressing pressure. The partial images (a1) to (a9) shown in FIG. 18A are obtained at a stage when the amount of exposure correction is set during the exposure control in the amount-of-exposure-correction setting routine in step S1406. FIG. 18B is a schematic view showing exemplary partial images (b1) to (b9) that are obtained by correcting the partial images (a1) to (a9) shown in FIG. 18A. That is, the partial images (b1) to (b9) shown in FIG. 18B are obtained by completing the processing for correcting the difference with respect to the partial image data in step S1407 of FIG. 14. A fingerprint image (c) shown in FIG. 18B is an example of a fingerprint image obtained by combination of the corrected partial images (b1) to (b9) shown in FIGS. 18B. That is, the fingerprint image (c) in FIG. 18B is an image combined after both the exposure control and the image correction are performed, and displays an improved image quality over the image (b) shown in FIG. 17.

Specifically, the partial images (a6) to (a9) shown in FIG. 17 are examples obtained when the brightnesses are increased, due to a change in the finger's pressing pressure, by 19%, 17%, 19%, and 18%, respectively, relative to the ideal value. Thus, the partial images (a6) to (a9) shown in FIG. 17 are somewhat saturated. In such a case, by controlling the amount of exposure, the fingerprint verification apparatus of the present embodiment can provide the partial images (a6) to (a9) in FIG. 18A which have respective brightness levels that are 19%, 9%, 3%, and 2% higher relative to the brightness ideal value and that are closer to the ideal value than the partial images (a6) to (a9) shown in FIG. 17.

In this case, suppose the first and second thresholds that have been described with reference to FIGS. 14 and 15 are set to 6% and 20%, respectively. One level of the amount of exposure adjustment for a pressuring-pressure change is assumed to be 8%. With this setting, upon obtaining the partial image (a6) shown in FIG. 18A, the verification unit 102 follows the routines shown in FIGS. 14 and 15. In this case, since the difference in brightness level of the obtained partial image (a6) is in the range of 6% to 20%, the verification unit 102 determines that the brightness change is caused by the finger's pressuring pressure (“Yes” in step S1502). The process, therefore, proceeds to the processing in step S1503. In step S1503, as is apparent from the calculation in step S1404 shown in FIG. 14, when the detected brightness is greater than the ideal value, the process proceeds to step S1504 since the difference value is less than “0”, and then the control member 123a reduces the amount of exposure adjustment by 8%. Since the partial image (a6) shown in FIG. 18A is an image from which the brightness change has been detected, the amount of exposure therefor has not been controlled. Controlling for reducing the amount of exposure by 8%, however, is performed before the image obtaining unit 101 obtains the next partial image (a7) shown in FIG. 18A.

As a result, the partial image (a7) in FIG. 18A which is subsequently obtained by the image obtaining unit 101 has a brightness level of +9%, which is 8% lower than that of the partial image (a7) shown in FIG. 17. Since the partial image (a7) shown in FIG. 18A still has a difference of 6% or more, processing for reducing the amount of exposure by another one level (8%) is performed. Consequently, the partial image (a8) shown in FIG. 18A has a brightness level of +3%, which is 16% lower than that of the partial image (a8) shown in FIG. 17. Since the partial image (a8) in FIG. 18A has a difference of 6% or less, no processing for controlling the amount of exposure is performed before the next partial image is obtained. Consequently, the partial image (a9) shown in FIG. 18A has a brightness level of +2%, which is 16% lower than that of the partial image (a9) shown in FIG. 17. As described above, when a partial image whose brightness level has changed within a predetermined range is obtained, processing for controlling the amount of exposure by one level is repeated before the next partial image is obtained. Thus, the fingerprint verification apparatus of the present embodiment can obtain the partial images (a1) to (a9) in FIG. 18A which have a more appropriate amount of exposure than the partial images (a1) to (a9) in FIG. 17.

Further, as shown in step S1408 of FIG. 14 and in FIG. 16, of the partial images (a1) to (a9) in FIG. 18A which have been obtained through the control of the amount of exposure, the image combining member 135 performs correction processing on partial images having a brightness level exceeding the first threshold. Specifically, with respect to the partial image (a6) shown in FIG. 18A, the image combining member 135 corrects a difference of +19% to be 0%, thereby obtaining the partial image (b6) shown in FIG. 18B. Similarly, with respect to the partial image (a7) shown in FIG. 18A, the image combining member 135 corrects a difference of +9% to be 0%, thereby obtaining the partial image (b7) shown in FIG. 18B. Since the partial images (a8) and (a9) in FIG. 18A have a difference of 6% or less, no image correction is performed by the image combining member 135. The image combining member 135 combines the partial images (b1) to (b9) in FIG. 18B, which are obtained through the above-described processing, to create the combined fingerprint image (c) shown in FIG. 18B. The fingerprint image (c) in FIG. 18B which is created as described above has a variation of 6% or less in brightness level. This indicates that the fingerprint verification apparatus of the present embodiment can provide high-quality fingerprint images.

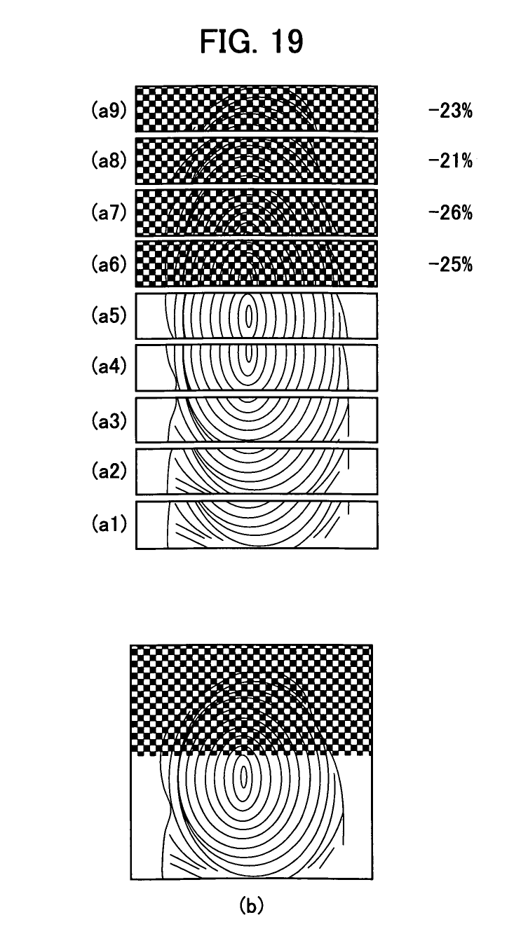

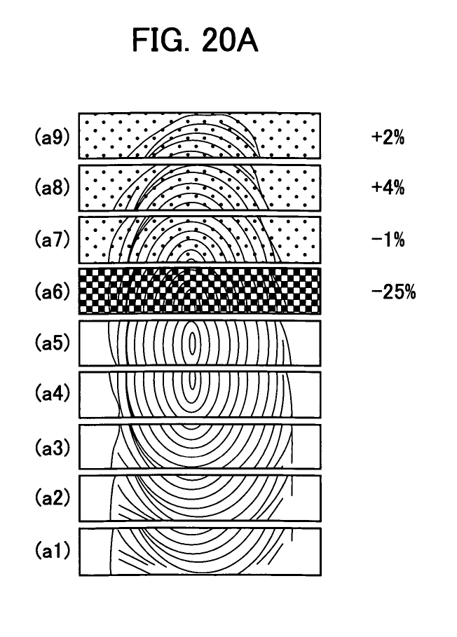

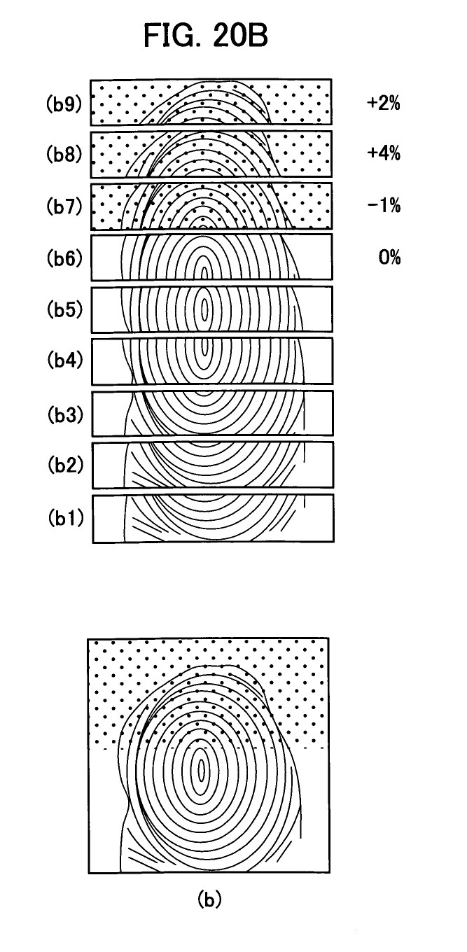

An operation of the fingerprint verification apparatus in response to a brightness change caused by a change in an external light environment will now be described with reference to FIGS. 19, 20A and 20B.

FIG. 19 is a schematic view showing exemplary partial images (a1) to (a9) and an exemplary fingerprint image (b). The partial images (a1) to (a9) are obtained by a known method in which the amount of exposure is not controlled, at the time of obtaining partial images, in response to a change in an external-light environment. The fingerprint image (b) shown in FIG. 19 is obtained by combination of the partial images (a1) to (a9) shown in FIG. 19. FIG. 20A is a schematic view showing exemplary partial images (a1) to (a9) that are obtained through the control of the amount of exposure, at the time of obtaining partial images, in response to a change in an external-light environment. The partial images (a1) to (a9) in FIG. 20A are obtained at a stage when the amount of exposure correction is set during the exposure control in the amount-of-exposure correction setting routine in step S1406. FIG. 20B is a schematic view showing exemplary partial images (b1) to (b9) that are obtained by correcting the partial images (a1) to (a9) shown in FIG. 20A. That is, the partial images (b1) to (b9) shown in FIG. 20B are obtained by completing the processing for correcting the difference with respect to the partial image data in step S1407 of FIG. 14. The fingerprint image (b) shown in FIG. 20B is obtained by combination of the corrected partial images (b1) to (b9) shown in FIG. 20B. That is, the fingerprint image (b) in FIG. 20B is an image combined after both the exposure control and the image correction are performed, and displays an improved image quality over the image (b) shown in FIG. 19.

Specifically, the partial images (a6) to (a9) shown in FIG. 19 are examples obtained when the brightnesses are considerably reduced, due to a change in the finger's pressing pressure, by 25%, 26%, 21%, and 23%, respectively, relative to the ideal value. Thus, the partial images (a6) to (a9) shown in FIG. 19 have somewhat under-saturated black. In such a case, by controlling the amount of exposure, the fingerprint verification apparatus of the present embodiment can provide the partial images (a6) to (a9) in FIG. 20A, which have respective brightness levels that are −25%, −1%, +4%, and +2% relative to the brightness ideal value and that are closer to the ideal value than the partial images (a6) to (a9) shown in FIG. 19.

In this case, suppose the first and second thresholds that have been described with reference to FIGS. 14 and 15 are set to 6% and 20%, respectively. With this setting, upon obtaining the partial image (a6) shown in FIG. 20A, the verification unit 102 follows the routines shown in FIGS. 14 and 15. Since the change in brightness level of the obtained partial image (a6) is 20% or more, the process proceeds to the processing in step S1506 and determines that the brightness change is caused by an abnormal factor, such as an external-light environment (“No” in step S1502). In step S1506, the control member 123a determines the amount of exposure correction (+25% in this case) corresponding to the difference (−25%). Next, in step S1507, the control member 123a corrects the amount of exposure and re-sets the corrected amount of exposure in the register. Since partial image (a6) shown in FIG. 20A is an image from which the brightness change has been detected, the amount of exposure therefor is not controlled. Controlling for the amount of exposure, however, is performed before the next partial image (a7) shown in FIG. 20B is obtained.

As a result, the partial image (a7) shown in FIG. 20A that is subsequently obtained by the image obtaining unit 101 has a brightness level of −1%, which is 25% higher than that of the partial image (a7) shown in FIG. 19. Since the partial image (a7) in FIG. 20A has a brightness level that is different from the ideal value by 6% or less, no processing for controlling the amount of exposure is performed before the next partial image is obtained. Consequently, the partial image (a8) in FIG. 20A has a brightness level of +4%, which is 25% higher than the partial image (a8) in FIG. 19, and the partial image (a9) in FIG. 20A has a brightness level of +2%, which is 25% higher than the partial image (a9) in FIG. 19. As described above, when a partial image whose brightness level has changed to exceed a predetermined threshold, processing for controlling the amount of exposure corresponding to the amount of change is performed before the next partial image is obtained. Thus, the fingerprint verification apparatus of the present embodiment can obtain the partial images (a1) to (a9) in FIG. 20A which have a more appropriate amount of exposure than the partial images (a1) to (a9) in FIG. 19.

Further, as shown in step S1408 of FIG. 14 and in FIG. 16, of the partial images (a1) to (a9) in FIG. 20A which have been obtained through the control of the amount of exposure, the image combining member 135 performs correction processing on partial images having a brightness level exceeding the first threshold. Specifically, with respect to the partial image (a6) shown in FIG. 20A, the image combining member 135 corrects a difference of −25% to be 0%, thereby obtaining the partial image (b6) shown in FIG. 20B. With respect to the partial images (a7), (a8), and (a9) in FIG. 20A, since they have a difference of 6% or less, no image correction is performed by the image combining member 135. The image combining member 135 combines the partial images (b1) to (b9) in FIG. 20B, which are obtained through the above-described processing, to create the combined fingerprint image (b) shown in FIG. 20B. The fingerprint image (b) in FIG. 20B which is created as described above has a variation of 6% or less in brightness level. This indicates that the fingerprint verification apparatus of the present embodiment can provide high-quality fingerprint images.

As described above, the fingerprint verification apparatus of the present embodiment combines partial images while controlling the amount of exposure by detecting a change in brightness and determining the cause of the change based on a difference in brightness level or by setting the types of changes in advance. Thus, the fingerprint verification apparatus can improve a uniformity of brightness between partial images, thereby enhancing the verification accuracy and the matching rate of the partial images. Additionally, combining the first embodiment and the present embodiment can achieve a fingerprint verification apparatus that can control the amount of exposure for each line at an initial stage of sequentially capturing partial images of a subject to thereby obtain an optimum amount of exposure and that can perform control so that the optimum amount of exposure is reached in accordance with a subject's optical-characteristic change and an environmental change during the movement of the subject.

The present embodiment, which uses a sweep-type sensor, can not only provide a high-accuracy fingerprint verification system, but can also simplify a circuit to thereby achieve a miniaturized circuit. The miniaturization of a processing circuit is preferable for applications requiring portability, including portable apparatuses, such as mobile personal computers, PDAs (personal data assistants), and mobile phones having a transmitter for transmitting information over an electromagnetic wave and a selector for selecting a desired destination.

Although the fingerprint verification system for verifying an individual's identify by using a fingerprint of a finger, which is a subject, has been described in the present embodiment, the present invention is not limited thereto. For example, this fingerprint verification system is equally applicable to a system for authenticating an individual by using an eye retina, features of a face, the shape of a palm, and the like, as long as such a system performs the verification based on a partial image of the subject. Although the system for verifying a subject performs the verification based on a combined image obtained by connecting partial images of the subject, the present invention is not limited thereto. For example, a sweep-type fingerprint sensor performs verification by comparing the partial image with a pre-registered image without detecting the same fingerprint region among lines of the partial images, and connecting the partial images.

The fingerprint verification apparatus of the third embodiment can capture images while changing the exposure condition at appropriate times during a single fingerprint-capturing period. Thus, the apparatus can provide high-quality image data to thereby achieve both high-accuracy verification and high-speed verification. Further, while the present embodiment has been described in conjunction with an example in which the control member 123a in the verification unit 102 shown in FIG. 1 controls the amount of exposure for each partial image, the control member 123c in the image obtaining unit 101 shown in FIG. 10 may control the amount of exposure for each partial image. Such an arrangement can also provide the same advantages.

Additionally, while the present embodiment has been described in conjunction with an example in which an optical CMOS sensor is used for the image capture device 104, a sensor employing another system, such as an electrostatic capacity system, may be used. In such a case, controlling the charge-storage condition for each partial image so as to compensate for a variation in the amount of charge accumulated in the pixels, in the same manner as the optical sensor, can provide the same advantages. Accordingly, the present invention can be applied to an image-capturing system sensor other than an optical sensor.

The present invention is not limited to the above embodiments and various changes and modifications can be made within the spirit and scope of the present invention. Therefore, to apprise the public of the scope of the present invention, the following claims are made.

What is claimed is:

1. A signal processing apparatus comprising:
an image capture device for capturing a plurality of images of a subject, the plurality of images including a first partial image and a plurality of second partial images; and
a control member for controlling a first mode and a second mode,
wherein, in the first mode, the image capture device captures the first partial image of the subject using a plurality of exposure conditions during relative movement of the subject and the image capture device, and the control member sets a respective one of the exposure conditions in accordance with the first partial image, and,
in the second mode, the image capture device sequentially captures the plurality of second partial images of the subject in accordance with the respective one of the exposure conditions set by the control member.

2. The signal processing apparatus according to claim 1, wherein the first partial image comprises a single first partial image.

3. The signal processing apparatus according to claim 1, wherein the first partial image comprises a plurality of partial images and the image capture device captures the plurality of first partial images using the plurality of exposure conditions.

4. The signal processing apparatus according to claim 1, further comprising a verification unit for performing verification by comparing the partial images with a pre-registered image.

5. The signal processing apparatus according to claim 4, wherein the verification unit verifies the subject in accordance with a brightness level for each partial image.

6. The signal processing apparatus according to claim 4, wherein the subject comprises a fingerprint.

7. A controlling method comprising:
capturing at least one first partial image of a subject using a plurality of exposure conditions during relative movement of the subject and an image capture device for image capture of the subject; and
setting a respective one of the exposure conditions in accordance with the at least one first partial image and sequentially capturing a plurality of second partial images of the subject in accordance with the respective one of the exposure conditions that was set.

8. A signal processing apparatus comprising:
an image capture device for capturing a plurality of partial images of a subject during relative movement of the subject and the image capture device;
a detection member for detecting a brightness level for each of the plurality of the partial images captured by the image capture device; and
an amount-of-exposure control member for performing control to set an amount of exposure for partial images to be subsequently captured, in accordance with the detected brightness level.

9. The signal processing apparatus according to claim 8, further comprising a changing member for changing the amount-of-exposure control member in accordance with a change in brightness level of the plurality of partial images during the relative movement of the subject and the image capture device.

10. The signal processing apparatus according to claim 9, wherein the changing member changes the amount-of-exposure control member between a case in which the change in brightness level is determined to be caused by a movement of the subject and a case in which the change in brightness level is determined to be caused by a change in an amount of light that is externally incident.

11. The signal processing apparatus according to claim 8, further comprising a correction member for performing correction on the partial images in accordance with the brightness level detected by the detection member.

12. The signal processing apparatus according to claim 8, further comprising a verification unit for performing verification by comparing the partial images with pre-registered images.

13. The signal processing apparatus according to claim 12, wherein the verification unit verifies the subject in accordance with the brightness level for each partial image.

14. The signal processing apparatus according to claim 12, wherein the subject comprises a fingerprint.

15. A controlling method comprising:
capturing a plurality of partial images of a subject during relative movement of the subject and an image capture device for image capture of the subject;
detecting a brightness level for each of the plurality of partial images captured by the image capture device; and
performing control to set an amount of exposure for partial images to be subsequently captured, in accordance with the brightness level detected.

16. A signal processing apparatus for sequentially capturing a plurality of partial images of a subject, the signal processing apparatus comprising:
a first control member for performing control to correct an amount of exposure for capturing a respective one of the partial images, the control performed in accordance with at least one partial image that is captured while an amount of exposure is changed;
a detection member for detecting a brightness level of the respective partial image that was captured with the amount of exposure corrected by the first control member; and
a second control member for performing control to change the amount of exposure corrected by the first control member in accordance with the brightness level detected by the detection member.

17. The signal processing apparatus according to claim 16, further comprising a verification unit for performing verification by comparing the respective partial image with a pre-registered image.

18. The signal processing apparatus according to claim 17, wherein the verification unit verifies the subject in accordance with a brightness level for each partial image.

19. The signal processing apparatus according to claim 17, wherein the subject comprises a fingerprint.

20. A controlling method for a signal processing apparatus for sequentially capturing a plurality of partial images of a subject, the controlling method comprising:
performing control to correct an amount of exposure for capturing a subsequent partial image in accordance with at least one captured partial image that is captured while an amount of exposure is changed;
detecting a brightness level of the subsequent partial image captured with the corrected amount of exposure; and
performing control to change the amount of exposure corrected in accordance with the brightness level detected.
